(19) United States
(12) Patent Application Publication
(10) Pub. No.: US 2026/0108886 A1
(43) Pub. Date: Apr. 23, 2026

(54) MICROFLUIDIC DEVICES WITH PAIRING REGIONS AND DROPLET GENERATORS

(71) Applicant: Hewlett-Packard Development Company, L.P., Spring, TX (US)

(72) Inventors: Viktor Shkolnikov, Palo Alto, CA (US); Alexander Govyadinov, Corvallis, OR (US)

(21) Appl. No.: 19/113,226

(22) PCT Filed: Oct. 14, 2022
(86) PCT No.: PCT/US2022/046712

§ 371 Date: Mar. 19, 2025

(51) Int. Cl. B01L 3/00

(52) U.S. Cl. CPC B01L 3/502761; B01L 2200/0647; B01L 2300/047; B01L 2300/0654; B01L 2300/0867; B01L 2400/0487

(57) ABSTRACT

Example microfluidic devices include a pairing region and a droplet generator. The pairing region comprises a first microfluidic channel including a first sensor, the first microfluidic channel fluidically coupled to a first fluid actuator and to receive a first aqueous fluid, and a second microfluidic channel including a second sensor, the second microfluidic channel fluidically coupled to a second fluid actuator and to receive a second aqueous fluid. The droplet generator comprises a merging chamber fluidically coupled to the first microfluidic channel, the second microfluidic channel, and a third microfluidic channel, the third microfluidic channel fluidically coupled to the merging chamber and to receive a carrier fluid, and a fluid ejector fluidically coupled to the merging chamber.

### BACKGROUND

Assessing interactions of biological particles, such as living cells, may be beneficial for use in various industries, particularly in the fields of biology and medicine. For example, cells may interact with other particles to generate a product and produce a detectable optical signal. The product, and resulting optical signal, may indicate a particular pathway is activated by the particle, which may be used for antibody discovery or lymphocyte interaction screening, among other purposes. Particles which cause the output of the optical signal may be sorted using fluorescence-activated cell sorting (FACS) systems, which utilize focused sheathed flow in a quartz cuvette or other similar flow, confine the particles in droplets, and deflect the droplets using electric fields based on the fluorescence response of the droplet. Such systems are slow, may involve input of many particles, and are expensive to use due to the specialized fluidics and complicated electrical and optical components.

### BRIEF DESCRIPTION OF THE DRAWINGS

FIGS. 1A-1B illustrate an example microfluidic device with a pairing region and droplet generator, in accordance with examples of the present disclosure.

FIGS. 2A-2D illustrate example microfluidic devices with pairing regions and droplet generators, in accordance with examples of the present disclosure.

FIGS. 3A-3B illustrate further example microfluidic devices with pairing regions and droplet generators, in accordance with examples of the present disclosure.

FIGS. 4A-4B illustrate example microfluidic devices with multiplexed pairing regions and droplet generators, in accordance with examples of the present disclosure.

FIG. 5 illustrates an example apparatus including a pairing region, droplet generator, and circuitry, in accordance with examples of the present disclosure.

FIGS. 6A-6B illustrate further example apparatuses including a pairing region, droplet generator, an optical sensing device, and circuitry, in accordance with examples of the present disclosure.

FIGS. 7A-7B illustrate example regions of a microfluidic device including an optically transparent window, in accordance with examples of the present disclosure.

FIG. 8 illustrates an example method for pairing and sorting particles using a microfluidic device, in accordance with the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Biological particles may be assessed for different functionalities. A biological particle, as used herein, includes or refers to a discrete biological system derived from a biologic sample, such as cells and derivatives of cells (e.g., chromosomes and proteins). In some examples, the biological particle may include a living cell, which is capable of being cultured. As a non-limiting example, biological particles may be assessed for identification of production of antibodies with particular functionalities, herein sometimes referred to as “an antibody-producing cell”. Antibody therapy may be used as a therapeutic modality for treatment of organisms. B-cells, a type of white blood cell, produce a variety of different antibodies exhibiting different functionalities. Another example antibody-producing cell is a hybridoma, a hybrid cell produced by a fusion of an antibody-producing lymphocyte (such as a B-cell) with a tumor cell (such as a myeloma cell). In some instances, to identify antibodies, a subject may be immunized and then a biologic sample from the subject is screened to identify antibody-producing cells that produce the target antibody. Screening a biologic sample for a particular antibody that exhibits a particular functionality, sometime referred to “an antibody of interest”, is time consuming and may involve the use of complex circuitry.

In some instances, to screen the antibody-producing cells, a second particle may be used that is designed to form a detectable reaction product with the target antibody secreted by the antibody-producing cell, sometimes herein referred to as a “detection particle”. A detectable reaction product includes or refers to a product at the end of a reaction, such as a reaction between the first particle or derivative thereof (e.g., produced antibody) and the second particle. The resulting detectable reaction product may generate a particular optical signal. Forming the detectable reaction product involves pairing the antibody-producing cell with the detection particle in order for the reaction to occur. In many instances, the pairing between particles is random and only a portion of the antibody-producing cells pair with respective detection particles, which results in wasted and unused antibody-producing cells, increasing costs and reducing the overall pool of potential antibodies to screen. Although the above describes antibody-producing cells, such as B-cells and hybdrioma cells, examples are not so limited and examples include pairing of other types of particles which may form a detectable reaction product. Similarly, examples are not limited to detection particles and/or detection particles targeted to antibodies, and may include pairing two living cells or other types of particles, such as to form hybridomas or for other purposes.

Examples are directed to a microfluidic device which aligns particles, a single pairing at a time, and encapsulate the paired particles into a fluid droplet, resulting increased pairing efficiency. By increasing pairing efficiency, the microfluidic device reduces fluid waste and reduces time for performing the alignment. Further, as the alignment occurs on-device, the device reduces risk of contamination of fluids and to the user. In some examples, the fluid droplet containing particles may be ejected as a single droplet containing the paired particles for further analysis, such as selection via fluorescent sorting. Example microfluidic devices include reservoirs to store the particles, which are connected to a pairing region upstream of a droplet generator. The pairing region includes input microfluidic channels and sensors disposed with the input microfluidic channels to detect a position of the particles, and fluid actuators to flow aqueous fluid from the reservoirs into the input microfluidic channels. In response to detecting a first particle in the first microfluidic channel (and not detecting a second particle in the second microfluidic channel), fluid flow is stopped or reduced in the first microfluidic channel and continues in the second microfluidic channel. Once a particle is detected in each microfluidic channel, the first and second particles are flown to the droplet generator. The droplet generator includes a merging chamber at a junction between the first and second input channel, and a third input microfluidic channel coupled to a reservoir containing carrier fluid. A fluid ejector is coupled to the merging chamber to draw aqueous fluid from the first and second input microfluidic channels and to draw carrier fluid from the third input microfluidic channel. The flow of the carrier fluid crosses or otherwise interacts with the flow of the aqueous fluids at the junction, thereby causing a fluid droplet containing the paired particles to form in the merging chamber. The fluid ejector may be further actuated to eject the fluid droplet from the device.

In some examples, a microfluidic device comprises a pairing region and a droplet generator. The pairing region including a first microfluidic channel including a first sensor, the first microfluidic channel fluidically coupled to a first fluid actuator and to receive a first aqueous fluid, and a second microfluidic channel including a second sensor, the second microfluidic channel fluidically coupled to a second fluid actuator and to receive a second aqueous fluid. The droplet generator including a merging chamber fluidically coupled to the first microfluidic channel, the second microfluidic channel, and a third microfluidic channel, the third microfluidic channel fluidically coupled to the merging chamber and to receive a carrier fluid, and a fluid ejector fluidically coupled to the merging chamber.

As used herein, a pairing region includes or refers to a portion of a microfluidic device in which alignment of particles is performed. A droplet generator refers to or includes a physical structure that generates fluid droplets of the first and second aqueous fluids using a carrier fluid. A merging chamber includes or refers to a chamber which is interconnected to the pairing region and a carrier fluid source. A fluid actuator includes or refers to circuitry and/or a physical structure that causes movement of fluid. A fluid ejector includes or refers to a physical structure to receive a fluid.

As used herein, an aqueous fluid includes or refers to an immiscible fluid, such as a fluid containing water, and which may contain particles. A particle includes or refers to a localize object or mass of material, which may be ascribed physical and/or chemical properties, such as volume, density, and/or mass. A fluid droplet (of aqueous fluids or containing particles) includes or refers to a discrete portion of fluid, which may be surrounded by a carrier fluid. A carrier fluid includes or refers to fluid that flows through portions of a microfluidic device and which carries particles, such as fluid droplets of the aqueous fluids containing paired particles. As an example of a fluid droplet of aqueous fluids, an immiscible fluid, such as an aqueous solution, is surrounded by an oil phase. As used herein, “paired particles”, “a set of paired particles” or “a pairing of particles” includes or refers to a set of at least two particles, which includes one particle from each (input) microfluidic channel of the pairing region.

In some examples, the microfluidic device further includes circuitry to align a first particle of the first aqueous fluid in the first microfluidic channel with a second particle of the second aqueous fluid in the second microfluidic channel via actuation of the first fluid actuator and the second fluid actuator and based on sensor signals from the first sensor and second sensor, and to form a fluid droplet containing the first particle and the second particle in the merging chamber via selective actuation of the fluid ejector.

In some examples, the pairing region further includes a first branching channel that intersects the first microfluidic channel and a second branching channel that intersects the second microfluidic channel, the first fluid actuator disposed within the first branching channel and the second fluid actuator disposed within the second branching channel.

In some examples, the first fluid actuator and the second fluid actuator are respectively disposed in the first microfluidic channel and in the second microfluidic channel.

In some examples, the first microfluidic channel and the second microfluidic channel are disposed in series with the merging chamber, and the first microfluidic channel and the second microfluidic channel are disposed in parallel with one another.

In some examples, the first sensor is disposed upstream from a first junction between the first microfluidic channel and the first fluid actuator, and the second sensor is disposed upstream from a second junction between the second microfluidic channel and the second fluid actuator.

In some examples, the microfluidic device further includes a third sensor disposed downstream from the first junction and a fourth sensor disposed downstream from the second junction, wherein the third sensor and the fourth sensor are disposed upstream from the merging chamber.

In some examples, the droplet generator further includes a fourth microfluidic channel fluidically coupled to the merging chamber and to receive the carrier fluid, wherein the third microfluidic channel and the fourth microfluidic channel are disposed to provide cross flows of the carrier fluid into the merging chamber.

Some examples are directed to an apparatus comprising a pairing region, a droplet generator, and circuitry. The pairing region including a first microfluidic channel including a first sensor, wherein the first microfluidic channel is fluidically coupled to a first fluid actuator and a first reservoir to receive a first aqueous fluid including a first particle, and a second microfluidic channel including a second sensor, wherein the second microfluidic channel is fluidically coupled to a second fluid actuator and a second reservoir to receive a second aqueous fluid including a second particle. The droplet generator including a merging chamber fluidically coupled to the first microfluidic channel and the second microfluidic channel, a third microfluidic channel fluidically coupled to the merging chamber and a third reservoir to receive a carrier fluid, and a fluid ejector fluidically coupled to the merging chamber. And, the circuitry to selectively actuate the first fluid actuator, the second fluid actuator, and the fluid ejector to align the first particle and the second particle in the pairing region and to form a fluid droplet containing the first particle and the second particle in the merging chamber.

In some examples, the pairing region and droplet generator form part of a microfluidic device including a housing that contains the pairing region and the droplet generator, wherein the first reservoir, the second reservoir, and the third reservoir are coupled to the housing.

In some examples, the circuitry is to cause the first fluid actuator and the second fluid actuator to align the first particle and the second particle via actuation of the first fluid actuator until the first sensor detects the first particle in the first microfluidic channel and via actuation of the second fluid actuator until the second sensor detects the second particle in the second microfluidic channel.

In some examples, the circuitry is to cause the first fluid actuator to align the first particle in the first microfluidic channel with the second particle in the second microfluidic channel by adjusting a firing rate of at least one of the first fluid actuator and the second fluid actuator responsive to sensor signals from the first sensor and the second sensor.

In some examples, the circuitry, in response to the alignment of the first particle in the first microfluidic channel and the second particle in the second microfluidic channel, is to actuate the fluid ejector to form the fluid droplet containing the first particle and the second particle via flow of the first aqueous fluid and the second aqueous fluid with an angled, crossed, or co-flow of the carrier fluid into the merging chamber.

Various examples are directed to methods of aligning particles and forming fluid droplets containing the particles. An example method comprises aligning a first particle with a second particle in a pairing region of a microfluidic device by: actuating a first fluid actuator of the microfluidic device until a first sensor disposed in a first microfluidic channel detects a presence of the first particle, and actuating a second fluid actuator of the microfluidic device until a second sensor disposed in a second microfluidic channel detects a presence of the second particle. The method further includes, in response, forming a fluid droplet containing the first particle and the second particle by actuating a fluid ejector of the microfluidic device, and thereby moving the first particle and the second particle into a merging chamber of the microfluidic device from the pairing region while moving carrier fluid into the merging chamber, and dispensing the fluid droplet containing the first particle and the second particle from the microfluidic device by further actuating the fluid ejector.

The first particle may include an antibody-producing cell and the second particle includes a sensor cell that forms a detectable reaction product with a target antibody secreted by the antibody-producing cell, and the fluid droplet contains the single antibody-producing cell and the single sensor cell.

As used herein, a sensor cell includes or refers to a biologic cell that is modified to model a pathway, express an enzyme under control of the pathway, and include a fluorogenic substrate. A fluorogenic substrate includes or refers to a molecule or complex which reacts with an enzyme (or other molecule) to generate a particular optical signal. The fluorogenic substrate may not be fluorescent or exhibits a first optical signal in a first state in which the pathway is not modulated, and exhibits an optical signal or a second optical signal that is different than the first optical signal in a second state in response to the pathway being modulated. However, examples are not limited to sensor cells and may include other types of probes, such as probes designed to bind to or otherwise interact with the first particle or a derivative thereof. A probe, as used herein, includes or refers to molecules or compounds that bind to or otherwise interact with a target, and in response, provides an optical signal.

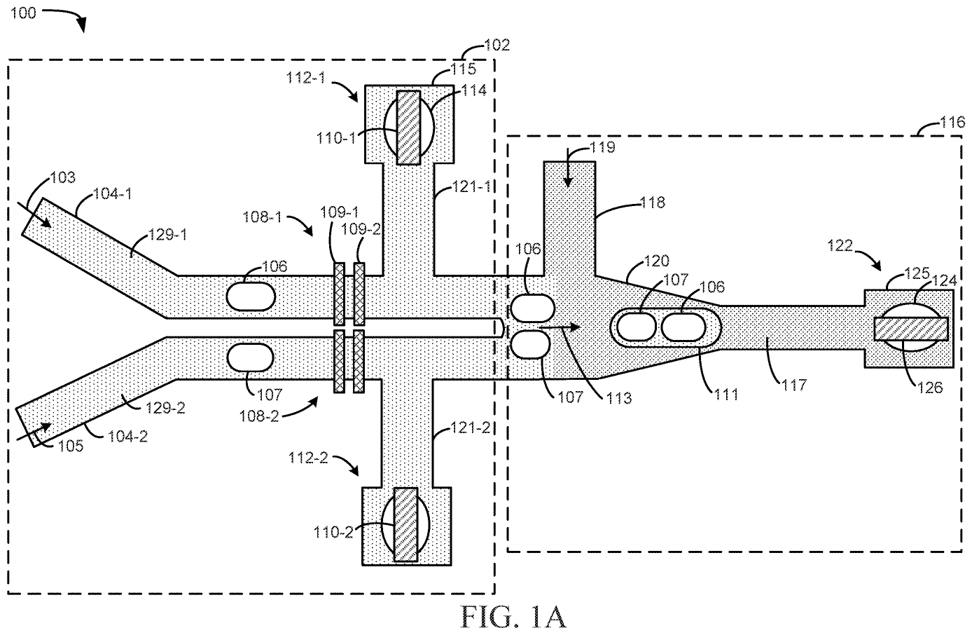

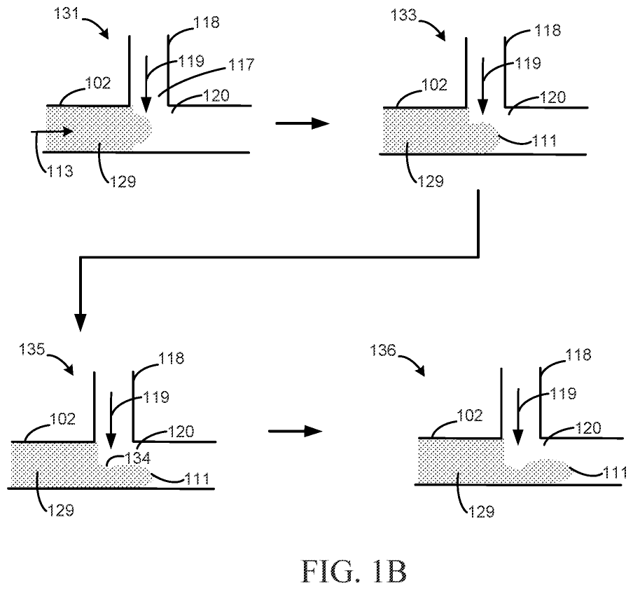

Turning now to the figures, FIGS. 1A-1B illustrate an example microfluidic device with a pairing region and droplet generator, in accordance with examples of the present disclosure.

As shown by FIG. 1A, the microfluidic device 100 includes a pairing region 102 and a droplet generator 116. The microfluidic device 100 may include reservoirs, chambers, and/or channels formed by and/or between substrates as etched or micromachined portions, which may enable manipulation and control of small volumes of fluid through microfluidic channels. For example, a microfluidic device 100 may enable manipulation and/or control of volumes of fluid on the order of microliters (μL), nanoliters, picoliters, or femtoliters. The chamber(s), wells, and/or channels may be defined by surfaces fabricated in the substrate(s) of the microfluidic device 100. A microfluidic channel refers to or includes a path through which a fluid or semi-fluid may pass, which may allow for transporting volumes of fluid on the order of μL, nanoliters, picoliters, or femtoliters. A chamber refers to or includes an enclosed and/or semi-enclosed region of the microfluidic device 100, which may be used to perform chemical processing on fluids therein. A reservoir refers to or includes a column capable of storing a volume of fluid.

The pairing region 102 comprises a first microfluidic channel 104-1 and a second microfluidic channel 104-2. The first microfluidic channel 104-1 includes a first sensor 108-1 and is fluidically coupled to a first fluid actuator 110-1 and to receive a first aqueous fluid 129-1. The first fluid actuator 110-1 may be actuated to move the first aqueous fluid 129-1 into and through the first microfluidic channel 104-1, as illustrated by arrow 103. The second microfluidic channel 104-2 includes a second sensor 108-2 and is fluidically coupled to a second fluid actuator 110-2 and to receive a second aqueous fluid 129-2. The second fluid actuator 110-2 may be actuated to move the second aqueous fluid 129-2 into and through the second microfluidic channel 104-2, as illustrated by arrow 105.

The microfluidic device 100 may pass a portion of the first aqueous fluid 129-1 and a portion of the second aqueous fluid 129-2 via the actuation of the first fluid actuator 110-1 and the second fluid actuator 110-2. Accordingly, the first and second fluid actuators 110-1, 110-2 may actively pass fluid into and through the pairing region 102, as shown by arrows 103, 105. A fluid actuator, as used herein, refers to or includes circuitry and/or a physical structure that causes movement of fluid. The fluid actuators 110-1, 110-2 may be fired or pulsed, which creates the fluid flow by pushing or pulling fluid within the pairing region 102 of the microfluidic device 100.

Example fluid actuators include electrodes, a fluidic pump, a magnetostrictive element, an ultrasound source, mechanical/impact driven membrane actuators, and magneto-restrictive drive actuators, among others. Example fluidic pumps include a piezo-electric pump and a resistor, such as a thermal inkjet resistor (TIJ).

In some examples, the fluid actuators 110-1, 110-2 each include a TIJ resistor. Activation of the TIJ resistor may create the flow of fluid by firing drops of fluid from the microfluidic device 100 and/or creating a vapor bubble, as further described below.

In some examples, the fluid actuators 110-1, 110-2 may form part of a fluid ejector 112-1, 112-2. As previously described, a fluid ejector refers to or includes a physical structure, such as an ejection chamber 115, to receive a fluid, such as from a manifold, fluid slot, or fluid hole array. The fluid ejectors, as illustrated by fluid ejector 112-1, may include an ejection nozzle 114 and a fluid actuator 110-1 disposed in an ejection chamber 115. As a specific example, the TIJ resistor may be actuated to cause firing of drops of fluid from the ejection nozzle 114, which creates the fluid flow through the microfluidic device 100 by pulling the fluid toward the ejection nozzle 114. The TIJ resistor (e.g., fluid actuator 110-1) may create bubbles that force the fluid droplets of fluid out of the ejection chamber 115. For example, a pulse of current may be passed through the fluid actuator 110-1 of fluid ejector 112-1 in the form of a TIJ resistor positioned in fluid ejector 112-1. The TIJ resister acts as a heater, and heat from the TIJ resistor causes vaporization of fluid in the ejection chamber 115 of the fluid ejector 112-1 to form the vapor bubble, which causes a pressure increase that propels the fluid droplet of fluid.

However, examples are not so limited and a variety of different types of resistors may be used in fluid ejectors 112-1, 112-2 (and 122). In some examples, the fluid actuators 110-1, 110-2 include piezoelectric-based pumps. The piezoelectric-based pump may generate pressure pulses that force fluid droplets of the aqueous fluid out of the ejection nozzle 114. In such piezoelectric-based pumps, a voltage may be applied to the fluid actuators 110-1, 110-2 (and 126) that is in the form of a piezoelectric element (e.g., piezoelectric material) located in the ejection chamber 115 of the fluid ejector 112-1, 112-2. When a voltage is applied, the piezoelectric element changes shape, which generates a pressure pulse that forces a fluid droplet of the aqueous fluid from the fluid ejectors 112-1, 112-2.

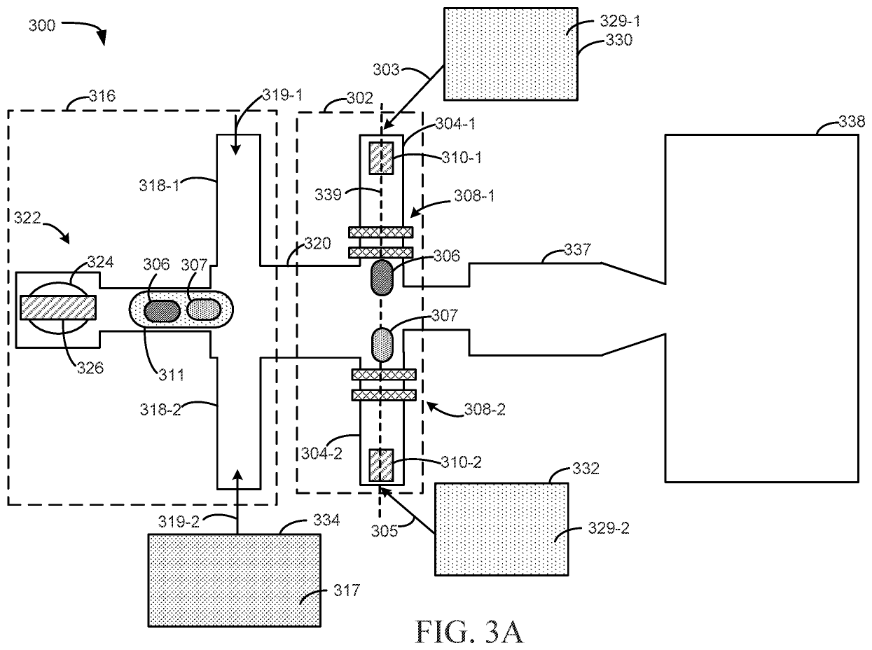

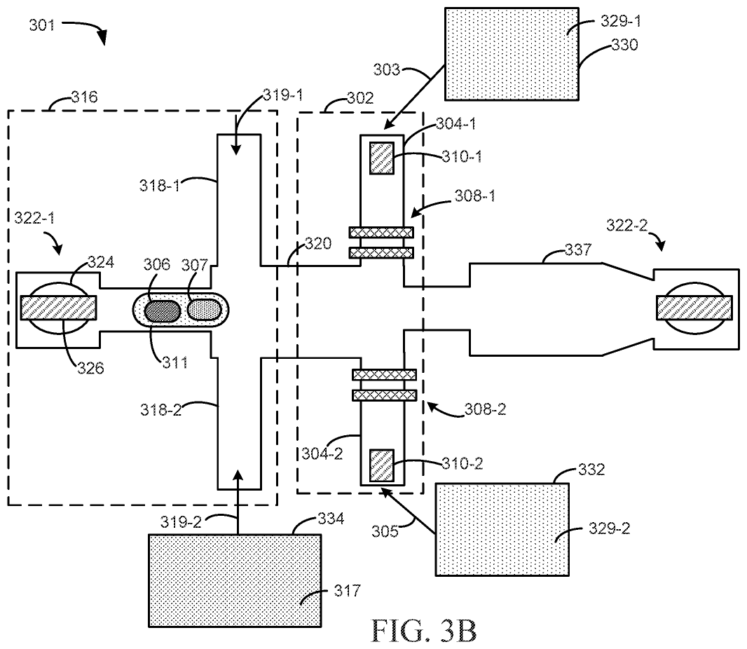

In some examples, as illustrated by FIG. 1A, the pairing region 102 further includes a first branching channel 121-1 that intersects the first microfluidic channel 104-1 and a second branching channel 121-2 that intersects the second microfluidic channel 104-2. In some examples, the first fluid actuator 110-1 is disposed with the first branching channel 121-1 and the second fluid actuator 110-2 is disposed with the second branching channel 121-2. In some examples, as shown by and referring to FIG. 3A, the first fluid actuator 310-1 and the second fluid actuator 310-2 are respectively disposed in the first microfluidic channel 304-1 and in the second microfluidic channel 304-2.

Referring back to FIG. 1A, the first sensor 108-1 may be disposed upstream from a first junction between the first microfluidic channel 104-1 and the first fluid actuator 110-1, and the second sensor 108-2 may be disposed upstream from a second junction between the second microfluidic channel 104-2 and the second fluid actuator 110-2. The sensors 108-1, 108-2 may include impedance sensors, image sensors, light sensors, and/or chemical sensors, among other types of sensors. The sensors 108-1, 108-2 may be used to detect a particle 106, 107 within the respective microfluidic channels 104-1, 104-2. For an impedance sensor, the first and second aqueous fluids 129-1, 129-2 may include a buffer solution that is non-conductive, such as a phosphate buffer and/or phosphate buffered saline. The particles 106, 107 may be conductive and an impedance detected by the impedance sensor may indicate the presence of a particle 106, 107. For a light sensor, light scattering with the microfluidic channels 104-1, 104-2 may be monitored. The light sensor may be used with bacteria and small particles, which may be difficult to sense using an image sensor.

In various examples, the sensors 108-1, 108-2 are impedance sensors that include electrodes, as illustrated by particular electrodes 109-1, 109-2. While FIG. 1A illustrates the sensors 108-1, 108-2 as including two electrodes, sensors may include additional number of electrodes, such as three electrodes or more. The impedance sensor may measure for impedance changes in the fluid 129-1, 129-2 passing by. As an example, the impedance sensor may be formed of electrodes 109-1, 109-2 that create an electric field within the fluid flow. As the fluid flows between the electrodes 109-1, 109-2 changes in the electric field may indicate that a particle 106, 107 is passing through. The change in impedance may include or be associated with different particle types. The electrodes 109-1, 109-2 may comprise members formed from electrically conductive material, such as an electrically conductive metal, which cooperate to apply an electrostatic field across the interior of the microfluidic channel 104-1, 104-2 upon being electrically charged. The electrodes 109-1, 109-2 may be electrically isolated from one another so as to form an electrical field through the contents of microfluidic channels 104-1, 104-2.

In some examples, the first aqueous fluid 129-1 includes a plurality of first particles, as illustrated by the particular first particle 106. As previously described, particles include or refer to a localize object or mass of material, which may be ascribed physical and/or chemical properties. The plurality of first particles may include test particles. A test particle includes or refers to a particle to be tested or assessed for exhibiting a particular functionality, such as modulating (e.g., activating or deactivating) a particular pathway or binding to a particular binding site, among other functionalities. In some examples, the first particles include biological particles. A biological particle includes or refers to a discrete biological system derived from a biologic sample, such as cells and derivatives of cells, including but not limited to chromosomes and proteins. In some examples, the biological particles may include living cells, which are capable of being cultured. For example, the first aqueous fluid 129-1 may include a biologic sample from a subject, such as a human or other animal. In some examples, the biological particles may include antibody-producing cells, such as B-cells or hybridoma cells. Non-limiting examples of biologic samples include saliva, blood, and other bodily fluids, as further described below.

The second aqueous fluid 129-2 may include a plurality of second particles, as illustrated by the particular second particle 107. In some examples, the plurality of second particles may include different types of particles than the plurality of first particles. In some examples, the plurality of second particles may include detection particles. A detection particles includes or refers to a particle that is capable of generating a detectable reaction product with or in response to a target particle. A target particle includes or refers to a particle exhibiting a particle feature or functionality, such as a test particle exhibiting a binding domain or producing antibodies or other derivatives that bind to the detection particle and modulate a particular pathway (e.g., a target antibody). In some examples, the target particle may itself, or via secreted antibodies or other derivative molecules, modulate the particular pathway that is of interest, sometimes herein referred to as “pathway of interest”. Modulating a pathway includes activating, deactivating, and/or reducing activity of a pathway.

In some examples, the plurality of first particles contained in the first aqueous fluid 129-1 may be screened to identify target particles using the plurality of second particles which include detection particles. As such, the first aqueous fluid 129-1 and/or a subset of the first particles may include target particles, and the second aqueous fluid 129-2 may include detection particles.

In some examples, the detection particle may be a sensor cell that models the pathway of interest, and when the pathway is modulated, an optical signal is output. An optical signal includes or refers to an electromagnetic signal or energy wave. As previously described, the sensor cell may include a biologic cell modified to model a pathway, to express an enzyme under control of the pathway, and to include a fluorogenic substrate, which acts as a probe. In some examples, the enzyme may be expressed in response to activation or other modulation of the pathway caused by an antibody produced by the first particle 106 (e.g., a B-cell). More particularly, the pathway may be stimulated by the antibody which leads to activation of downstream transcription factors and resulting in the enzyme being expressed. The fluorogenic substrate may react with the enzyme to generate a particular optical signal, e.g., fluorescent signal. For example, the fluorogenic substrate may include a fluorophore or pairs of fluorophores which are activated responsive to the fluorogenic substrate reacting with the enzyme.

Example enzymes include beta-lactamase, such as extended-spectrum beta-lactamase, AmpC beta-lactamase, and carbapenemase. Other non-limiting example enzymes include β-D-galactosidase, β-D-glucuronidase (GUD), β-D-xylosidase, tryptophan-deaminase, cysteine desulfhydrase, and tryptophanase, among other enzymes. Examples are not limited to enzymes, and in some examples, a fluorescent protein expression may be induced as described below.

The sensor cell may formed of a variety of different types of biologic cells, such as Jurkat cells, HepG2 cells, LS-180 cells, RA-1 cells, FreeStyle 293F cells, HEK 293T cells, CHO-K1 cells, Hela cells, NIH3T3 cells, HCT-116 cells, 22Rv1 cells, ME-180 cells, ECV304 cells, THP-1 cells, CTLL-2 cells, Ba/F3 cells, TF1 cells, and A375 cells, among other types of cells.

Non-limiting example pathways include anti-oxidant response, aryl hydrocarbon receptor, B-cell receptor, C/EBP, cAMP/PKA, Cell Cycle pRB-E2F, DNA damage/p53 Response, ER Stress Response, Glucocorticoid Receptor, Heat Shock Response, Hedgehog, hypoxia, Interleukin 1, Interleukin 4,JAK/STAT, MAPK, Myc, MAPK/EGFR/Ras/Raf, MAPK/MEK/B-raf, NFkB, PI3K/AKT/FOXO3, and PI3K/AKT/mTOR, and PKC and Ca2+, among others.

Example substrates used in the fluorogenic substrate include cephalosporins, such as cephalothin, cefoxitin, and cefotaxime, and/or drug intermediates, such as ACLH, Trans-ACLE, Carbapenem core, and GCLE, among others. Other non-limiting example substrates include 4-methylumbelliferyl-β-D-glucuronide (MUG), 4-methylumbelliferyl-β-D-galactoside (MUGA), o-nitrophenyl-β-D-galactopyranoside (ONPG), 5-bromo-4-chloro-3-indolyl-β-D-galactopyranoside (XGAL), p-nitrophenyl-β-D-glucuronide (PNPG), phenolphthalein-β-D-glucuronide (PHEG), 5-bromo-4-chloro-3-indolyl-β-D-glucuronide (XGLUC), Indoxyl-β-D-glucuronide (IBDG), 5-bromo-6-chloro-3-indolyl-β-D-glucuronide (magenta-glc), 6-chloro-3-indolyl-β-D-β-D-glucuronide (salmon glc), and L-tryptophan, among others.

As a specific example, the fluorogenic substrate includes a fluorescence resonance energy transfer (FRET)-based substrate. With a FRET-based substrate, the substrate includes two fluorophores. The two fluorophores include donor and acceptor fluorophores, such as coumarin and fluorescein. A donor fluorophore is a fluorophore that is initially excited by light and may transfer energy to the acceptor fluorophore. The acceptor fluorophore is a fluorophore that receives the transferred energy. In the absence of enzyme expression, the fluorogenic substrate remains intact and the two fluorophores remain proximate to one another. When proximate to one another, excitation of the donor fluorophore is followed by nonradiative energy transfer from the donor fluorophore to the acceptor fluorophore. Using the example of coumarin and fluorescein, excitation of coumarin results in fluorescence resonance energy transfer to fluorescein, and emission of a green fluorescent signal. In the presence of the enzyme, the fluorogenic substrate is cleaved, resulting in separation of the two fluorophores and disrupting the energy transfer. In the particular example, excitation of coumarin results in emission of blue fluorescent signal. Accordingly, the fluorogenic substrate acts as a probe, and provides an indication of modulation of the pathway.

Examples are not limited to FRET-based substrates and/or fluorogenic substrates. In some examples, the fluorogenic substrate may include a photoinduced electron transfer (PET)-based substrate, an intramolecular charge transfer (ICT)-based substrate, or an aggregation-induced emission (AIE)-based substrate, among other types.

A PET-based substrate includes or refers to a substrate in which there is an electron transfer process initiated by the enzyme (or other mechanism) that causes an excited electron to transfer from a donor to an acceptor (similar to FRET but including molecules not limited to fluorophores) of the substrate. For example, the electron donating moiety or molecule of the fluorogenic substrate may include an amino acid or nucleotide which may quench an acceptor fluorophore or other moiety of the fluorogenic substrate when in close proximity to one another. In the absence of enzyme expression, the fluorogenic substrate remains intact and the donor and acceptor remain proximate to one another. In the response to enzyme expression, the enzyme cleaves the fluorogenic substrate, resulting in emission by the acceptor fluorophore, as an example.

ICT-based substrates operate similarly to a PET-based substrate with the electronic transfer occurring between moieties of the same molecule. With ICT-based substrates, the optical signal (e.g., fluorescence moiety) is activated or quenched in response to changes in the folding of the molecule, which may change responsive to an enzyme and/or other component binding to or cleaving the molecule. For example, in response to binding or cleaving, the molecule of the fluorogenic substrate may twist or otherwise change in formation, causing the donor and acceptor to be proximate or not to one another.

An AIE-based substrate includes or refers to a substrate including an organic luminophore (e.g., fluorescent dye) that changes a level of luminescence in a solution state verses an aggregate (or solid) state. For example, the organic luminophore may exhibit higher (or lower) photoluminescence in the aggregate state verses solution state. The AIE-based substrate may transition from a solution state to an aggregate state by binding to a probe or enzyme and, in response, to restrict intermolecular motion and/or cleave dissolution promoting ligands by the enzyme to induce aggregate forms, among other mechanisms.

In other examples, the detection particles may not include sensor cells. For example, the detection particles may include beads that are functionalized with a probe. A bead refers to or includes a material formed in a three-dimensional shape, such as a sphere, an ellipsoid, oblate spheroid, and prolate spheroid shapes. The bead(s) may be of a size such that the beads are capable of moving through components of the microfluidic device 100. For example, the functionalized bead(s) may be between 1 μm and 20 mm in diameter as non-limiting examples. The functionalized bead(s) may be formed of, for example, glass, polymer, silica, alumina, silicon carbide, tungsten carbide iron oxide steel, silica coated metal, boron nitride, or other suitable material. The functionalized bead(s) may be spherical, such as beads, or may not be spherical, such as disk-shaped, rock or gravel-like, or other suitable shapes.

As previously described, a probe refers to or includes molecules or compounds that bind to or otherwise interacts with a target, and in response, provides a detectable optical signal. The probe may include a complex of nucleic acids, proteins, protein fragments, and/or nanoparticles coupled with a detectable moiety, molecule, or compound that exhibits the optical signal in response to an interaction with the first particle 106 or derivative thereof, such as a fluorescent moiety. The probes may react or bind to the target of the first particle 106 or a derivative of the first particle 106 (e.g., antibody) and in response, exhibit the optical signal, such as a particular fluorescent signal.

Example probes include and/or may be selected from a group consisting of a linear fluorescence resonance energy transfer (FRET) probe, a molecular beacon, a linear oligonucleotide (ODN) probe, dual FRET donor and acceptor beacons, an autoligation FRET probe, a probe coated with a bacterial phage MS2 fused with a fluorescent protein, and/or a probe with a fragment complementation of the fluorescent protein, and combinations thereof. In some examples, linear FRET probes or molecular beacons may be used due to ease of manufacturing and optically sensing the probes as compared to other probes. However, examples are not so limited.

Linear FRET probes include two linear oligonucleotides that are fluorescently labeled at a 5′ and a 3′ end with donor and acceptor fluorophores, respectively, to form a FRET pair. The oligonucleotides are designed to hybridize to adjacent regions on the target, e.g., target nucleic acid of the first particle 106, such that the donor and acceptor fluorophores are brought into close proximity when both oligonucleotides are hybridized to the same target. Excitation of donor fluorophore is followed by nonradiative energy transfer from it to the acceptor fluorophore on the other oligonucleotides, when both are in close proximity to each other, such as being closer than about 10 nanometers (nm).

Molecular beacons are hair pin oligonucleotides labeled at one end with a reporter fluorophore and at the other end with a quencher. A reporter fluorophore is a fluorophore, e.g., a molecule or compound, that emits a particular fluorescent signal. A quencher is a molecule or compound that suppresses or reduces the fluorescent signal of the reporter fluorophore when the quencher and reporter are proximate to one another. The molecular beacons have a complimentary sequence region near the ends and a hairpin region in the center. The complimentary regions hybridize in the absence of a target, bringing the fluorophore and quencher together which renders the beacon non-fluorescent. In the presence of the target, the beacon opens up, with the center hairpin region binding to the target, and not allowing the end regions to be next to each other, thus preventing quenching from occurring. This renders the beacon fluorescent.

A linear ODN probe includes a fluorescently labeled oligonucleotide that is complementary to the target, and may include a fluorophore that provides a detectable fluorescent signal. In various examples, a volume of the linear ODN probe is used such that the fluorescent signal is above a background signal of unbound probes. To detect the intracellular target, multiple linear ODN probes may bind to at least one target associated with the first particle 106. The linear FRET probes, described above, may include two linear ODN probes.

Dual FRET donor and acceptor beacons combine the concepts of the linear FRET probes with the molecular beacons. More particularly, there is a donor molecular beacon labeled with a donor fluorophore at one end (5′ or 3′ end) and with a quencher at the other end (3′ or 5′ end) and an acceptor molecular beacon labeled with an acceptor fluorophore at one end (3′ or 5′ end) and with a quencher at the other end (5′ or 3′ end). Each of the donor and acceptor molecular beacons have a complimentary sequence region near the ends and a hairpin region in the center. The complimentary regions hybridize in the absence of an intracellular target, bringing the (donor or acceptor) fluorophore and quencher together which renders the beacon non-fluorescent. Each of the donor and acceptor molecular beacons are designed to bind to a different portion of the target. In the presence of the target, each beacon opens up, with the center hairpin region binding to the target, and not allowing the end regions to be next to each other, thus preventing quenching from occurring. The center hairpin regions of the molecular beacons are designed to hybridize to adjacent regions on the target, such that the donor and acceptor fluorophores are brought into close proximity when both beacons are hybridized to the same target. Excitation of donor fluorophore is followed by nonradiative energy transfer from the donor fluorophore to the acceptor fluorophore on the other oligonucleotide, when both are in close proximity to each other, such as being closer than about 10 nm.

Autoligation FRET probes include two linear oligonucleotides that are fluorescently labeled at a 5′ and a 3′ end with donor and acceptor fluorophores. The oligonucleotide with the donor fluorophore includes a quencher disposed proximate to the donor fluorophore, such the donor fluorophore is quenched when the two oligonucleotides are not bound to the target. The two linear oligonucleotides hybridize to adjacent regions on the target, and in response, the quencher is displaced and ligation brings the donor and acceptor fluorophores into close proximity.

A probe coated with a bacterial phage MS2 fused with a fluorescent protein, such as green fluorescent protein (GFP), red fluorescent protein (RFP), and yellow fluorescent protein (YFP), among others, may be used in some examples. The MS2-fluorscent protein complex binds to multiple hairpin sequences in the 3′ untranslated region of messenger RNA (mRNA), which provides a fluorescent signal that is higher than the background signal.

Probes with a fragment complementation of a fluorescent protein include two RNA-binding proteins, which each carry a fragment of the fluorescent protein. The two RNA-binding proteins bind to adjacent regions on the RNA sequence such that the two fragments of the fluorescent protein are brought together to activate the fluorescent signal.

The optical signal, e.g., fluorophore, may be provided by a fluorescent moiety and/or protein. Example fluorescent moieties and/or proteins include fluorophores, fluorescent proteins, quantum dots, and organic dyes. Some specific example fluorophores include coumarin, fluorescein, resorufin, tetraphenylethylene (TPE), sulfonated cyanines, boron-dipyrromethene (BODIPY), Hemi-cyanani, among others. Examples are not limited to fluorophores and may include other optical signals, such as luciferase. Non-limiting examples of optical signals include GFP, RFP, YFP, phycoerythrin, allophycocyanin, luciferase, fluorescein, Dylight 649, Alexa647, and Alex750, among others and in various combinations thereof.

Although the above describes the example probes as binding to targets of nucleic acids, examples are not so limited. For example, a probe may bind to other molecules, such as proteins, lipids, and non-biologic compounds that are less than 800 daltons, sometimes referred to as “a small molecule”. For example, the probe may be an aptamer. An aptamer is an oligonucleotide that folds into a three-dimensional shape to bind non-covalently to the target small molecule. Example small molecules include toxins, antibiotics, drugs, and heavy metals. In some examples, in response to binding to the small molecule, the aptamer may change shape and thus change a FRET response or otherwise provide an optical signal. Further, examples are not limited to probes which include nucleic acids, and may include molecular probes that include a protein, protein fragment, or nanoparticle, such as the above-described MS2-fluorscent protein complex and RNA-binding proteins, enzymes, or ribonucleoprotein complexes, among others.

The droplet generator 116 comprises a merging chamber 120, a third microfluidic channel 118, and a fluid ejector 122. The droplet generator may include a physical structure that generates fluid droplets of the first and second aqueous fluids 129-1, 129-2 using a carrier fluid 117.

The droplet generator 116 may operate using multiphase flow comprising a chemical component (e.g., carrier fluid 117) in a continuous phase and another chemical component (e.g., first and second aqueous fluids 129-1, 129-2) in a droplet phase. For example, a carrier fluid 117 may be in a continuous phase and used to generate and carry a fluid droplet of the first and second aqueous fluids 129-1, 129-2, e.g., in a droplet phase. The droplet generator 116 includes the merging chamber 120 connected to reservoirs containing the first aqueous fluid 129-1, the second aqueous fluid 129-2, and the carrier fluid 117 via interconnected microfluidic channels 104-1, 104-2, 118. Each of the fluids 117, 129-1, 129-2 are drawn into the merging chamber 120 via a fluid ejector 122. As the first and second aqueous fluids 129-1, 129-2 are drawn into the merging chamber 120, individual fluid droplets of the first and second aqueous fluids 129-1, 129-2 may be separated from each other, with the carrier fluid interposed between and/or generally surrounding the fluid droplets of the first and second aqueous fluids 129-1, 129-2, as illustrated by the particular fluid droplet 111 containing the first and second particles 106, 107.

More particularly, to form fluid droplets, the fluid ejector 122 may cause flow of the carrier fluid 117 from the third microfluidic channel 118 and flow of the first and second aqueous fluids 129-1, 129-2 from the pairing region 102. For example, the fluid actuator 126 of the fluid ejector 122 may be actuated to cause pulling forces on each of the carrier fluid 117 and the first and second aqueous fluids 129-1, 129-2, and in response, cause a first flow of the carrier fluid 117, as illustrated by arrow 119, and a second flow of the first and second aqueous fluids 129-1, 129-2, as illustrated by arrow 113. The first flow of the carrier fluid 117 and the second flow of the aqueous fluids 129-1, 129-2 may intersect and cause the formation of the fluid droplets of the aqueous fluids 129-1, 129-2, as illustrated by fluid droplet 111 containing the first and second particles 106, 107. For example, the first flow of the carrier fluid 117 may form a cross-flow or an angle-flow with respect to the second flow of the aqueous fluids 129-1, 129-2, which causes formation of fluid droplets of the aqueous fluids 129-1, 129-2. In such examples, fluids 117, 129-1, 129-2 are drawn from the pairing region 102 and the third microfluidic channel 118, and the aqueous fluids 129-1, 129-2 are immiscible with the carrier fluid 117, which allows for the aqueous fluids 129-1, 129-2 to segregate into fluid droplets of the aqueous fluids 129-1, 129-2 with the carrier fluid 117 spacing therebetween and around the fluid droplets of the aqueous fluids 129-1, 129-2.

As illustrated, the merging chamber 120 is fluidically coupled to the first microfluidic channel 104-1, the second microfluidic channel 104-2, and the third microfluidic channel 118. A merging chamber includes or refers to a portion of the microfluidic device at which the first aqueous fluid, the second aqueous fluid, the carrier fluid intersect. The third microfluidic channel 118 is fluidically coupled to the merging chamber 120 and to receive the carrier fluid 117. As shown by FIG. 1A, in some examples, the first microfluidic channel 104-1 and the second microfluidic channel 104-2 are disposed in series with the merging chamber 120, and the first microfluidic channel 104-1 and the second microfluidic channel 104-2 are disposed in parallel with one another.

As used herein, the term “in series” includes or refers to components (e.g., channels, chambers, reservoirs) of a microfluidic device that are connected end-to-end in a line to form a path for fluid to flow. The term “in parallel” includes or refers to components of a microfluidic device that are to a same input. While microfluidic channels may be disposed parallel to one another, microfluidic channels may be disposed alongside one another at an angle. An example of an microfluidic device 100 including microfluidic channels 104-1, 104-2 in parallel and disposed at an angle relative to one another for at least a portion of the microfluidic channels 104-1, 104-2 is shown by FIG. 1A.

The fluid ejector 122 is fluidically coupled to the merging chamber 120. The fluid ejector 122 includes an ejection nozzle 124 and a fluid actuator 126 disposed in an ejection chamber 125, as previously described in connection with fluid ejectors 112-1, 112-2. An ejection chamber includes or refers to a semi-enclosed region of the microfluidic device 100, with the ejection nozzle 124 and fluid actuator 126 disposed within and/or through a surface of the ejection chamber 125. The fluid actuator 126 may be disposed in the ejection chamber 125 coupled to the ejection nozzle 124 and the merging chamber 120, and is positioned in line with the ejection nozzle 124. For instance, the fluid actuator 126 may be positioned directly above or below the ejection nozzle 124. The fluid actuator 126 may be fired or pulsed, which creates the fluid flow by pushing or pulling fluid within the merging chamber 120 of the microfluidic device 100. Actuation of the fluid actuator 126 may cause some fluid contained in the merging chamber 120 to be dispensed or expelled out of the ejection nozzle 124. The fluid actuator 126 may be actuated via application of a voltage or current by circuitry, as further described below. More specifically, the fluid actuator 126 of the fluid ejector 122 may be actuated to form a fluid droplet 111 containing the particles 106, 107.

In some examples, the microfluidic device 100 may further include or be coupled to reservoirs to store the first aqueous fluid 129-1, the second aqueous fluid 129-2, and the carrier fluid 117. As previously described, a reservoir refers to or includes a column capable of storing a volume of fluid. For example and referring to FIG. 3A, the microfluidic device 300 includes a first reservoir 330 fluidically coupled to the first microfluidic channel 304-1 and to store the first aqueous fluid 329-1, and a second reservoir 332 fluidically coupled to the second microfluidic channel 304-2 and to store the second aqueous fluid 329-2. The microfluidic device 300 may further include a third reservoir 334 to store the carrier fluid 317 and fluidically coupled to the third microfluidic channel 318-1 (and the optional fourth microfluidic channel 318-2). The reservoirs 330, 332, 334 may be sized and shaped to hold the fluid while a portion of the fluid flows through other portions of the microfluidic device 300.

In some examples, the reservoirs 330, 332, 334 may contain a volume of fluid between about 1 μL to about 10 milliliters (mL). In some examples, the reservoirs 330, 332, 334 may contain a volume of fluid between about 10 μL to about 10 mL, about 10 μL to about 500 μL, about 200 μL to about 800 μL, about 500 μL to about 1 mL, about 1 mL to about 10 mL, about 2 mL to about 4 mL, among other ranges. In some examples, the reservoirs 330, 332, 334 may have a height and length ranging from about 1 millimeter (mm) by about 1 mm to about 10 mm by about 10 mm, or from about 2 mm by about 2 mm to about 8 mm by about 8 mm. In some examples, the reservoirs 330, 332, 334 may have a width ranging from about 0.3 mm to about 5 mm, about 0.5 mm to about 2.5 mm, about 0.5 mm to about 2.5 mm, about 1 mm to about 5 mm, about 1 mm to about 3 mm, or about 2 mm to about 4 mm. The reservoirs 330, 332, 334 may have a cross-sectional area larger than a cross-sectional area of other portions of the microfluidic device 300, such as microfluidic channels 304-1, 304-2.

In some examples, the first and second aqueous fluids 329-1, 329-2 may include a medium and/or buffer. For example, the first aqueous fluid 329-1 may include a biologic sample containing the plurality of test particles (e.g., living cells) that is mixed with a medium and/or buffer and loaded into the first reservoir 330 via a fluid inlet. The second aqueous fluid 329-2 may include a medium and/or buffer including a plurality of detection particles (or other second particles), which is loaded into the second reservoir 332 via a fluid inlet. The carrier fluid 317 may be loaded into the third reservoir 334 via a fluid inlet. A fluidic inlet is an inlet port, e.g., an aperture, of the microfluidic device 300.

Referring back to FIG. 1A, some examples, the carrier fluid 117 may include a silicon oil or fluorinated oil, such as FC-40 or FC-3283. Non-limiting examples of the carrier fluid include FC-40, FC-43, FC-77, fluorophoroheptane (FC-84), FC-3283, perfluoro-n-octane, perfluorodecalin, perfluorophenanthrene, perfluorohexyloctane, octofluoropropane, decafluorobutane, perfluoropentane, perfluorohexane, perfluorooctane, decafluoropentane, perfluoro(2-methyl-3-pentaone), perfluoro-15-crown-5-ether, bis-(perfluorobutyl) ethane, perfluorobutyl tetrahydrofuran, bi-perfluorohexyl ethane, perfluoro-n-hexane, perfluorooctyl bromide, perfluorotributylamine, perfluorotripentylamine, and perfluorotripropylamine, among others. In some examples, the carrier fluid 117 may include a non-fluorinated oil, such as polyphenylmehtylsiloxane, polydimethylsiloxane, hexadecane, tetradecane, octadecane, dodecane, mineral oil, isopar, or squalene. However examples are not so limited and may include other types of carrier fluids and aqueous fluids that are immiscible.

The first and second aqueous fluids 129-1, 129-2 may include a variety of types of fluids used to drive biochemical processes. Example aqueous fluids include a biologic sample fluid, buffer fluids, and other reagents in fluids. Buffer fluids refer to or include fluids which assist in maintaining a pH within the fluids, such as mitigating or resting pH changes and/or maintaining the pH within a range. Example buffer fluids include a solution with a weak base or acid, such as a solution containing citrate, acetate, or phosphate salts. The biologic sample fluid may include an aqueous solution or fluid containing a sample, in solid or fluid form, and/or reagents. A biologic sample fluid, as used herein, refers to or includes any material, collected from a subject, such as biologic material and carried in a fluid. Examples are not so limited and may include a variety of fluids which contain reagents.

In various examples, the microfluidic device 100 may be operated to align a first particle 106 contained in the first aqueous fluid 129-1 with a second particle 107 contained in the second aqueous fluid 129-2 in the pairing region 102 and form a fluid droplet 111 containing the first particle 106 and the second particle 107 in the merging chamber 120. As used herein, two (or more) particles are aligned if they are disposed parallel to one another along a same plane such that a first particle does not extend in front of or behind the second particle by greater than half of the width of the first particle.

During operation, the first fluid actuator 110-1 may be actuated (or fired) until the first sensor 108-1 detects a presence of the first particle 106, and then the actuation of the first fluid actuator 110-1 is stopped, thereby halting the first particle 106 proximate to (e.g., above) the first sensor 108-1. The second fluid actuator 110-2 is actuated until the second sensor 108-2 detects the presence of the second particle 107, and then the actuation of the second fluid actuator 110-2 is stopped, thereby halting the second particle 107 proximate to (e.g., above) the second sensor 108-2. The first and second fluid actuators 110-1, 110-2 and sensors 108-1, 108-2 may work in parallel to align the particles 106, 107. Once the particles 106, 107 are aligned, the fluid actuator 126 of the fluid ejector 122 may be actuated, moving first and second aqueous fluids 129-1, 129-2 containing the particles 106, 107 toward and into the merging chamber 120 and drawing carrier fluid 117 into merging chamber 120 to form the fluid droplet 111 containing the first particle 106 and the second particle 107.

The movement of the fluids 117, 129-1, 129-2 and formation of the fluid droplet 111 may involve multiple actuations or firing of the fluid actuator 126 of the fluid ejector 122. In some examples, the fluid actuator 126 of the fluid ejector 122 may again be actuator to move the fluid droplet 111 containing the first particle 106 and second particle 107, such as to eject the fluid droplet 111 containing the particles 106, 107 from the microfluidic device 100 through the ejection nozzle 124. In some examples, the fluid droplet 111 is ejected to a substrate, such as to a specific well of a microwell plate or other type of substrate. The particles 106, 107 may be cultured in the well, and assessed for a detectable reaction product.

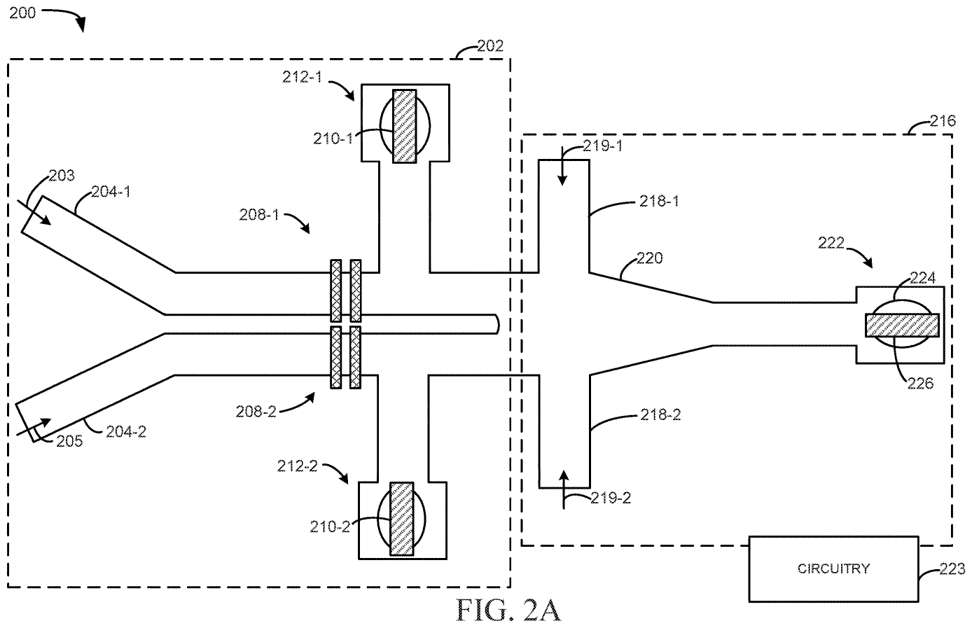

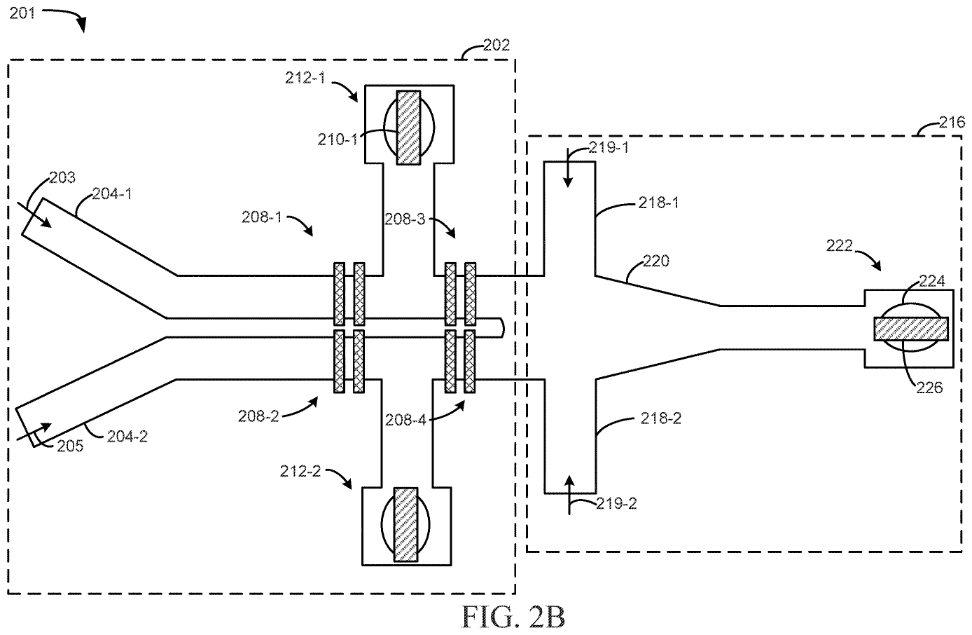

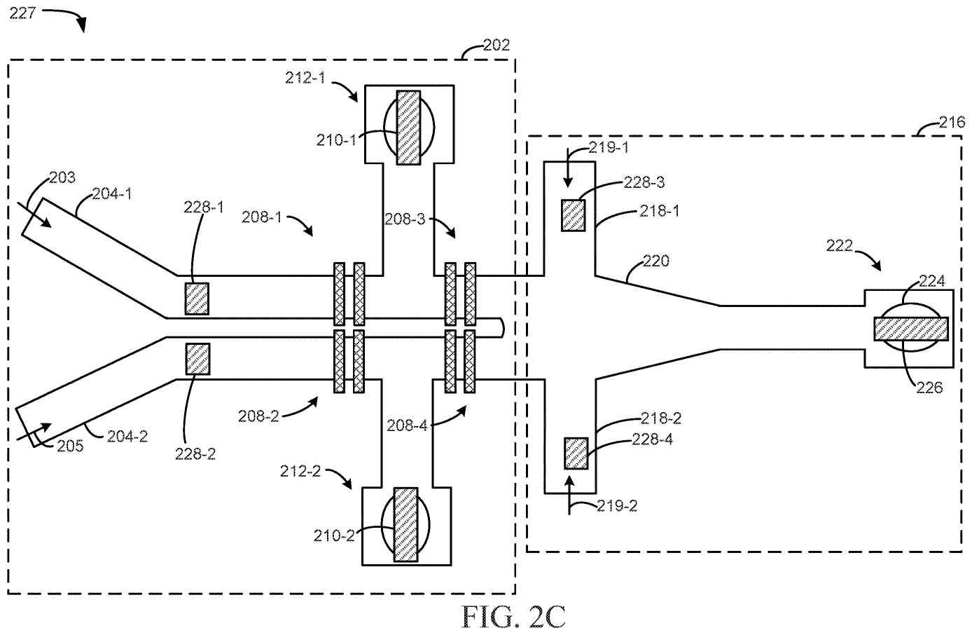

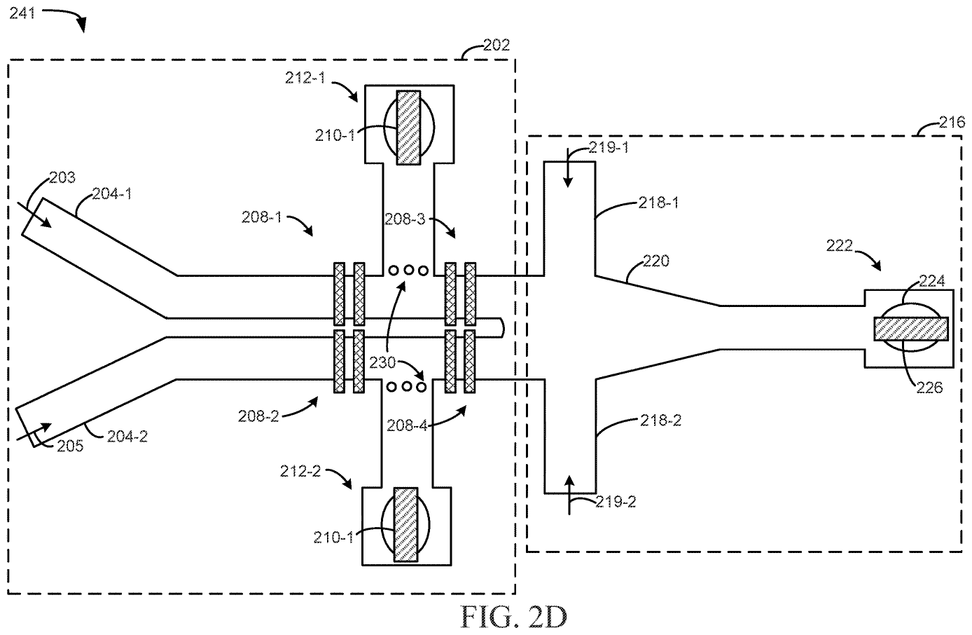

In various examples, the operation of the microfluidic device 100 may be controlled or driven by circuitry. For example, and as shown by and referring to FIG. 2A, the microfluidic device 200 may include or is couplable to circuitry 223. The circuitry 223 may align the first particle of the first aqueous fluid in the first microfluidic channel 204-1 with a second particle of the second aqueous fluid in the second microfluidic channel 204-2 via actuation of the first fluid actuator 210-1 and the second fluid actuator 210-2 and based on sensor signals from the first sensor 208-1 and the second sensor 208-2, and to form a fluid droplet containing the first particle and the second particle in the merging chamber 220 via selective actuation of the fluid ejector 222.

FIG. 1B shows a close-up view of a portion of the droplet generator 116 of the microfluidic device 100 of FIG. 1A and corresponding fluid droplet 111 formation. As shown at 131, the carrier fluid 117 is flowing as a first flow into the merging chamber 120 from the third microfluidic channel 118, as illustrated by arrow 119, as the first and second aqueous fluids 129 enter the merging chamber 120 from the pairing region 102. As previously described, the first and second aqueous fluids 129 flow as a second flow that intersects the first flow of the carrier fluid 117, as illustrated by arrow 113. As shown at 133, the first and second aqueous fluids 129 expand into the merging chamber 120 and start forming a fluid droplet 111 of the first and second aqueous fluids 129 containing the particles. As shown at 135, as the first and second aqueous fluids 129 continue to expand into the merging chamber 120, a neck shape 134 forms, and as shown at 136, the fluid droplet 111 of the first and second aqueous fluids 129 separates from the remaining portion of the first and second aqueous fluids 129 by breaking off at the neck shape 134.

The microfluidic device 100 illustrated by FIGS. 1A-1B may include variations, some of which are illustrated by FIGS. 2A-4B. The variations may include, but are not limited to, additional sensors, additional fluid actuators, different types of fluid actuators, placement of the fluid actuators, reservoirs to store fluid, number of microfluidic channels, barriers, optically transparent windows in or forming part of the microfluidic device, and/or an internal or external optical detection device.

FIGS. 2A-2D illustrate example microfluidic devices with pairing regions and droplet generators, in accordance with examples of the present disclosure. The microfluidic devices of FIGS. 2A-2D may include an implementation of the microfluidic device 100 of FIGS. 1A-1B, including at least some of substantially the same features and components, as illustrated by the common numbering. The common features and components are not repeated for ease of reference.

For example, each of the microfluidic devices 200, 201, 227, 241 of FIGS. 2A-2D include a pairing region 202 and a droplet generator 216. Each pairing region 202 includes a first microfluidic channel 204-1 with a first sensor 208-1 fluidically coupled to a first fluid actuator 210-1 and a second microfluidic channel 204-2 with a second sensor 208-2 fluidically coupled to a second fluid actuator 210-2. The first and second fluid actuators 210-1, 210-2 may form part of fluid ejectors 212-1, 212-2. Each droplet generator 216 includes a merging chamber 220, a third microfluidic channel 218-1, a fourth microfluidic channel 218-2, and a fluid ejector 222. The fourth microfluidic channel 218-2 is fluidically coupled to the merging chamber 220 and to receive the carrier fluid.

Referring to FIG. 2A, the third microfluidic channel 218-1 and the fourth microfluidic channel 218-2 are disposed to provide crossing flows of the carrier fluid into the merging chamber 220, as illustrated by arrows 219-1, 219-2. Crossing flow of carrier fluid may be used to provide greater control and/or formation of fluid droplets as compared to using the third microfluidic channel 218-1 alone, such as illustrated by microfluidic device 100 of FIG. 1A. For example, the crossing flows may be used to provide flow focusing for droplet formation. The third microfluidic channel 218-1 and the fourth microfluidic channel 218-2 may be coupled to a reservoir that stores the carrier fluid, such as the third reservoir 334 illustrated by FIG. 3A.

As previously described and illustrated by FIG. 2A, in some examples, the microfluidic device 200 includes or is coupled to circuitry 223. The circuitry 223 may selectively actuate (e.g., fire or pulse) the first fluid actuator 210-1, the second fluid actuator 210-2, and the fluid ejector 222 to align a first particle and a second particle in the pairing region 202 and to form a fluid droplet containing the first particle and second particle in the merging chamber 220.

The microfluidic device 201 may operate similarly to that described above in connection with the microfluidic device 100 of FIGS. 1A-1B. For example, the first fluid actuator 210-1 may be actuated (or fired) to draw first aqueous fluid, as illustrated by arrow 203, until the first sensor 208-1 detects a presence of a first particle and the second fluid actuator 210-2 is actuated to draw second aqueous fluid, as illustrated by arrow 205, until the second sensor 208-2 detects the presence of the second particle to align the first and second particles in the pairing region 202. Once the particles are aligned, the fluid actuator 226 of the fluid ejector 222 may be actuated, moving first and second aqueous fluid containing the particles toward and into the merging chamber 120 and drawing carrier fluid into merging chamber 220 via the third and fourth microfluidic channels 218-1, 218-2 and to form a fluid droplet containing the first particle and second particle. The fluid actuator 226 may be further actuated to eject the fluid droplet from the microfluidic device 200 through ejection nozzle 224, as previously described.

In some examples, as illustrated by the microfluidic device 201 of FIG. 2B, the pairing region 202 may include additional sensors. For example, the microfluidic device 201 includes the first sensor 208-1 disposed upstream from a first junction between the first microfluidic channel 204-1 and the first fluid actuator 210-1, and the second sensor 208-2 is disposed upstream from a second junction between the second microfluidic channel 204-2 and the second fluid actuator 210-2. The microfluidic device 201 further includes a third sensor 208-3 disposed downstream from the first junction and a fourth sensor 208-4 disposed downstream from the second junction, wherein the third sensor 208-3 and the fourth sensor 208-4 are disposed upstream from the merging chamber 220. Said differently, the first sensor 208-1 and the second sensor 208-2 are disposed on a first side of the fluid actuators 210-1, 210-2 and the third sensor 208-3 and fourth sensor 208-4 are disposed on a second side of the fluid actuators 210-1, 210-2. The third sensor 208-3 and fourth sensor 208-4 may be used to detect if particles have moved into the merging chamber 220. For example, the sensor signals from the third sensor 208-3 and fourth sensor 208-4 may be used as feedback to verify movement and alignment of the particles. In some examples, in response to an error (e.g., not detecting a particle), the aqueous fluid may be flowed to a waste reservoir, ejected to a waste well, and/or pulled back into one or both of the first and second microfluidic channels 204-1, 204-2 using the fluid actuators 210-1, 210-2 and/or additional fluid actuators, such as further illustrated by FIG. 2C and FIGS. 3A-3B.

The third sensor 208-3 and fourth sensor 208-4 may include any of the sensors previously described. Although various figures illustrate sensors comprising two electrodes each, examples are not so limited. In some examples, an array of electrodes (3 or more) may be used to detect a particle.

In some examples, the pairing region 202 and/or the droplet generator 216 may include additional fluid actuators. For example and referring to FIG. 2C, the microfluidic device 227 includes additional fluid actuators 228-1, 228-2 in the pairing region 202 and additional fluid actuators 228-3, 228-4 forming part of the droplet generator 216. In some examples, the additional fluid actuators 228-1, 228-2, 228-3, 228-4 may include fluid pumps, such as push or pull pumps. In some examples, the fluid pumps may include TIJ resistors which are disposed in microfluidic channels 204-1, 204-2, 218-1, 218-2. More specifically, a third fluid actuator 228-1 may be disposed in the first microfluidic channel 204-1, a fourth fluid actuator 228-2 may be disposed in the second microfluidic channel 204-2, a fifth fluid actuator 228-3 may be disposed in the third microfluidic channel 218-1, and a sixth fluid actuator 228-4 may be disposed in the fourth microfluidic channel 218-2.

The first fluid actuator 210-1 and second fluid actuator 210-2 may be actuated to draw first aqueous fluid and second aqueous fluid into the first and second microfluidic channels 204-1, 204-2, as previously described. The third fluid actuator 228-1 and fourth fluid actuator 228-2 may be actuated, in some examples, in response to sensor signals, such as to assist with stopping fluid flow and/or to reverse the flow of fluid, in the opposite direction of arrows 203, 205, and to align the particles. In some examples, in response to detecting a particle in one of the first and second microfluidic channels 204-1, 204-2 and not in the other via sensor signals from the first and second sensors 208-1, 208-2, the respective third fluid actuator 228-1 and fourth fluid actuator 228-2 may be actuated to draw the particle in the direction opposite of arrows 203, 205. As another example, if sensor signals from the third and/or fourth sensors 208-3, 208-4 indicate no particle is detected, the respective third fluid actuator 228-1 and fourth fluid actuator 228-2 may be actuated to draw the fluid back over the first and second sensors 208-1, 208-2 for detecting the particles and/or realigning the particles. The fifth fluid actuator 228-3 and sixth fluid actuator 228-4 may be actuated to assist with the fluid droplet generation.

The additional fluid actuators 228-1, 228-2, 228-3, 228-4 may provide greater fluid control, particle alignment, and droplet formation. In some examples, the additional fluid actuators 228-1, 228-2, 228-3, 228-4 may reduce wasted particles by allowing for feedback and fluid adjustment to resolve misalignment of particles and/or clumping of particles within the microfluidic device 227.

In some examples, particles may potentially travel from the first and second microfluidic channels 204-1, 204-2 toward the fluid actuators 210-1, 210-2. To prevent this flow, as shown by and referring to FIG. 2D, the microfluidic device 241 may include a plurality of barriers 230. For example, the pairing region 202 further includes a plurality of barriers 230 at a first junction between the first microfluidic channel 204-1 and the first fluid actuator 210-1 and at a second junction between the second microfluidic channel 204-2 and the second fluid actuator 210-2. The barriers 230 may prevent particles from escaping into or to the first fluid actuator 210-1 and the second fluid actuator 210-2. The barriers 230 include structures that enable fluid flow, while not allowing particles to enter, such as pillars, wires or other shapes. As with FIG. 2B, the microfluidic device 227 includes four sensors 208-1, 208-2, 208-3, 208-4. The first and second sensors 208-1, 208-2 are disposed on a first side (e.g., upstream from) of the barriers 230 and the third and fourth sensors 208-3, 208-4 are disposed on a second side (e.g., downstream from) of the barriers 230.

FIGS. 3A-3B illustrate further example microfluidic devices with pairing regions and droplet generators, in accordance with examples of the present disclosure. The microfluidic devices of FIGS. 3A-3B may include an implementation of the microfluidic device 100 of FIGS. 1A-1B, including at least some of substantially the same features and components, as illustrated by the common numbering. The common features and components are not repeated for ease of reference.

As illustrated by FIG. 3A, in some examples, the microfluidic device 300 includes a pairing region 302 including a first microfluidic channel 304-1 and a second microfluidic channel 304-2 that are disposed in series along a plane 339 and the merging chamber 320 of the droplet generator 316 is disposed generally orthogonal to the plane 339. For instance, the first microfluidic channel 304-1 and the second microfluidic channel 304-2 are disposed in series along plane 339 and orthogonal to the merging chamber 320. Similar to the microfluidic device 200 illustrated in FIG. 2A, the droplet generator 316 further includes the third and fourth microfluidic channels 318-1, 318-2 fluidically coupled to a reservoir 334 that stores carrier fluid 317 and the fluid ejector 322 fluidically coupled to the merging chamber 320.

In some examples, the microfluidic device 300 further includes a first fluid actuator 310-1 and a second fluid actuator 310-2, which may include push pumps. The first fluid actuator 310-1 and the second fluid actuator 310-2 may be respectively disposed in the first microfluidic channel 304-1 and the second microfluidic channel 304-2, and may drive fluids 329-1, 329-2 from reservoirs 330 and 332 respectively and as illustrated by arrows 303, 305, with particles 306, 307 through the first microfluidic channel 304-1 and the second microfluidic channel 304-2. Similar to the microfluidic device 100 of FIG. 1A, a first sensor 308-1 is disposed in the first microfluidic channel 304-1 and a second sensor 308-2 is disposed in the second microfluidic channel 304-2.

In some examples, the microfluidic device 300 further includes a waste reservoir 338 fluidically coupled to the pairing region 302. The waste reservoir 338 may be fluidically coupled to the pairing region 302 via a holding chamber 337. The waste reservoir 338 may be disposed orthogonal to the plane 339. The waste reservoir 338 may be in a same layer of the microfluidic channels 304-1, 304-2, 318-1, 318-2, in some examples.

In operation, the first fluid actuator 310-1, and with the same frequency of the second fluid actuator 310-2, is fired until either (or both) a first particle 306 is detected by the first sensor 308-1 or a second particle 307 is detected by the second sensor 308-2. If the first particle 306 is detected, the first fluid actuator 310-1 frequency is halved, but the fluid actuators 310-1, 310-2 may continue to fire until the second particle 307 is detected by second sensor 308-2. Similarly if the second particle 307 is detected by the second sensor 308-2, the second fluid actuator 310-2 is frequency is halved, but the fluid actuators 310-1, 310-2 continue to fire until a first particle 306 is detected by the first sensor 308-1. Once both particles 306, 307 are detected (e.g., by sensors 308-1, 308-2), the fluid actuators 310-1, 310-2 are stopped.

Once the particles 306, 307 are in the respective positions, the fluid actuator 326 of the fluid ejector 322 fires, moving the two particles 306, 307 together into the merging chamber 320. In the merging chamber 320, the carrier fluid 317 from the third reservoir 334 merges with the first and second aqueous fluids 329-1, 329-2 from the first and second reservoirs 330, 332 to form a fluid droplet 311 containing the first and second particles 306, 307. The fluid droplet 311 containing the first and second particles 306, 307 may be sent downstream. For example, the fluid ejector 322, via the fluid actuator 326, may be fired to move the fluid droplet 311 through the merging chamber 320 and dispense it out of the microfluidic device 300 through the ejection nozzle 324. The fluid droplet 311 containing the first and second particles 306, 307 may be dispensed into a specific well of a microwell plate.

In some examples, the particles 306, 307 in the well (or other region of a substrate) may be cultured. For example, the paired particles 306, 307 may include an antibody-producing cell and a detection particle, and may be cultured to produce antibodies that interact with the detection particle, which result in an optical signal. Thus, each well may produce a specific antibody, which may then be interrogated and selected for. However, examples are not limited to antibody-producing cells and may include pairing of other types of particles resulting detectable reaction products. The waste reservoir 338 may collect waste fluid when the fluid ejector 322 is not firing.

In some examples, as illustrated by FIG. 3B, the microfluidic device 301 includes a second fluid ejector 322-2 fluidically coupled to the pairing region 302. The microfluidic device 301 may include an implementation of the microfluidic device 300 of FIG. 3A, including at least some of substantially the same features and components, as illustrated by the common numbering, but with the additional fluid ejector 322-2 instead of a waste reservoir. For instance, the microfluidic device 301 may include pairing region 302 including a first microfluidic channel 304-1, a second microfluidic channel 304-2, a first fluid actuator 310-1, a second fluid actuator 310-2, a first sensor 308-1, and a second sensor 308-2. The microfluidic device 301 further includes droplet generator 316 including a merging chamber 320, a third microfluidic channel 318-1, a fourth microfluidic channel 318-2, and a first fluid ejector 322-1 to form fluid droplets of aqueous fluids. As previously described, the first fluid ejector 322-1 may draw fluids to form a fluid droplet containing paired particles and to dispense the fluid droplet. As illustrated in FIG. 3B, a second fluid ejector 322-2 may be disposed opposite of the first fluid ejector 322-1 and may be fluidically coupled to the pairing region 302, such as via the holding chamber 337. The second fluid ejector 322-2 may dispense waste or other fluids (other than fluid droplets containing paired particles) into a well or other substrate or vessel.

In operation, the microfluidic device 301 may have involve synchronized firing of the first and second fluid actuators 310-1, 310-2 disposed in the first and second microfluidic channels 304-1, 304-2 with firing of the second fluid ejector 322-2. In a default mode or when particles are not detected, the second fluid ejector 322-2 is continuously actuated or fired to pull first and second aqueous fluids 329-1, 329-2 from the first and second reservoirs 330, 332. When either a first particle 306 or a second particle 307 is detected by the first sensor 308-1 or second sensor 308-2, the opposite fluid actuator is actuated or fired to keep the first particle or second particle 306, 307 proximate to the first sensor 308-1 or second sensor 308-2 and stop pumping if the particle moves away from the first sensor 308-1 or second sensor 308-2 (and further starts in response to the particle again being detected). When the other of the first particle 306 or a second particle 307 is detected by the first sensor 308-1 or second sensor 308-2, the second fluid ejector 322-2 ceases firing and the first fluid ejector 322-1 is actuated or fired to pull the first and second particles 306, 307 toward the merging chamber 320, along with the carrier fluid 317 pulled from the third reservoir 334 (as shown by arrows 319-1, 319-2), to form the fluid droplet 311 containing the first and second particles 306, 307. The first fluid ejector 322-1 may be further fired to eject the fluid droplet 311 from the microfluidic device 301.

As a specific example, the second fluid ejector 322-2 is actuated to simultaneously draw first and second aqueous fluids 329-1, 329-2 from the first and second reservoirs 330, 332. A first particle 306 is detected by the first sensor 308-1, and in response, the first fluid actuator 310-1 is actuated along with the second fluid ejector 322-2 to keep the first particle 306 proximate to the first sensor 308-1 and to continue to draw the second aqueous fluid 329-2 from the second reservoir 332. If the first sensor 308-1 no longer detects the first particle 306, the first fluid actuator 310-1 ceases firing. Once a second particle 307 is detected by the second sensor 308-2, the second fluid ejector 322-2 ceases firing and the first fluid ejector 322-1 is actuated or fired to form the fluid droplet 311 containing the first and second particles 306, 307.

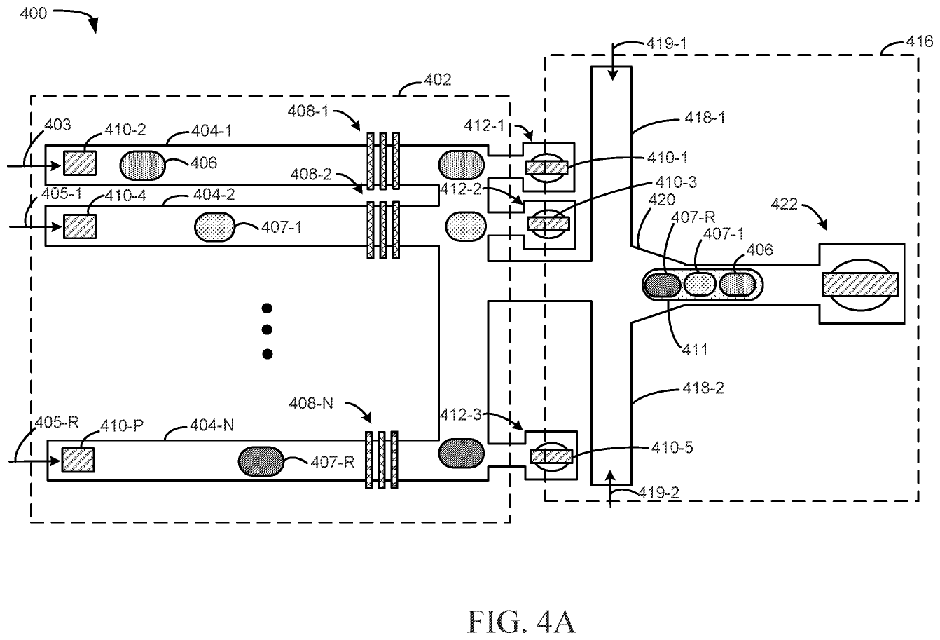

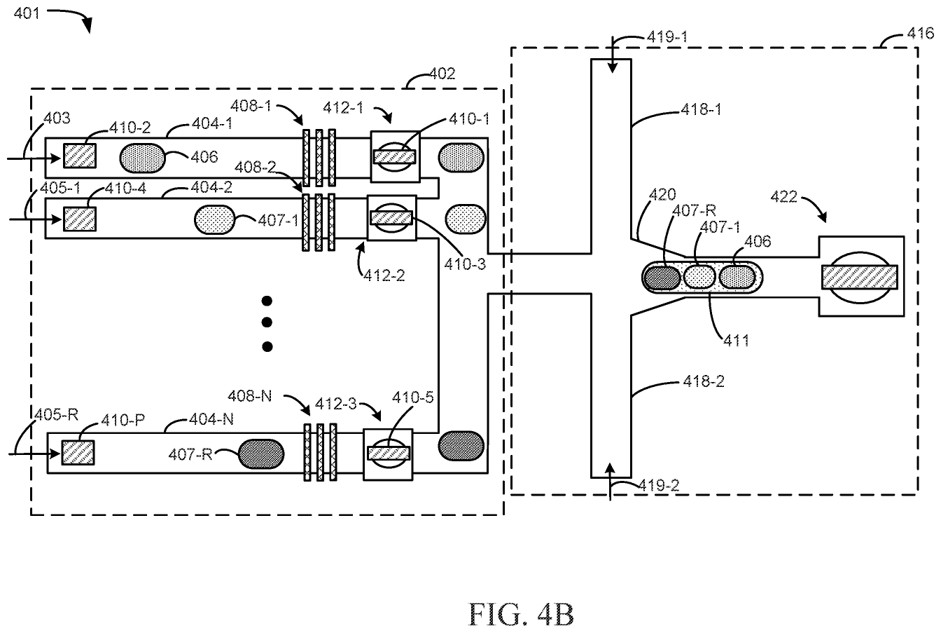

FIGS. 4A-4B illustrate example microfluidic devices with multiplexed pairing regions and droplet generators, in accordance with examples of the present disclosure. The microfluidic devices 400, 401 of FIGS. 4A-4B may include an implementation of the microfluidic device 100 of FIGS. 1A-1B, including at least some of substantially the same features and components, as illustrated by the common numbering. The common features and components are not repeated for ease of reference. In some examples, the pairing region 402 may include more than two microfluidic channels 404-1, 404-2, 404-N. Such pairing regions may be referred to as “multiplexed pairing regions” in that the first particle 406 may be assessed for multiple functionalities or features at the same time using multiple detection particles or is otherwise paired with a plurality of different types of second particles 407-1, 407-R.

The microfluidic device 400, 401 of FIGS. 4A-4B include a pairing region 402 including a plurality of microfluidic channels 404-1, 404-2, 404-N, wherein N includes more than two. Each of the plurality of microfluidic channels 404-1, 404-2, 404-N in the pairing region 402 includes a respective sensor 408-1, 408-2, 408-N and fluid actuators 410-1, 410-2, 410-3, 410-4, 410-5, 410-P. The fluid actuators 410-1, 410-2, 410-3, 410-4, 410-5, 410-P drive the flow of aqueous fluids from respective reservoirs (not illustrated by FIGS. 4A-4B), as shown by the arrows 403, 405-1, 405-R.

In some examples and as shown by FIGS. 4A-4B, each of the plurality of microfluidic channels 404-1, 404-2, 404-N in the pairing region 402 includes multiple fluid actuators 410-1, 410-2, 410-3, 410-4, 410-5, 410-P. For example and referring to FIG. 4A, each microfluidic channel 404-1, 404-2, 404-N includes a fluid ejector 412-1, 412-2, 412-3, including fluid actuators 410-1, 410-3, 410-5, fluidically coupled to the microfluidic channels 404-1, 404-2, 404-N via branching channels, as previously described by FIG. 1A. The fluid ejectors 412-1, 412-2, 412-3 are downstream of the sensors 408-1, 408-2, 408-N. Each microfluidic channel 404-1, 404-2, 404-N in the pairing region 402 further includes a fluid actuator (e.g., a pump) 410-2, 410-4, 410-P upstream of the sensors 408-1, 408-2, 408-N.

The flow of aqueous fluids within the pairing region 402 may operate similar to that described by FIG. 3B. For example, in a default mode or when particles 406, 407-1, 407-R are not detected, the fluid ejectors 412-1, 412-2, 412-3 are each continuously actuated or fired to pull aqueous fluids from reservoirs (not illustrated by FIG. 4A) into the microfluidic channels 404-1, 404-2, 404-N, as illustrated by arrows 403, 405-1, 405-R. When either a first particle 406, a second particle 407-1, or a third (or more) particle 407-R is detected by the first sensor 408-1, the second sensor 408-2, or the Nth sensor 408-N, the opposite fluid actuator is actuated or fired to keep the respective particle 406, 407-1, 407-R proximate to the respective sensor 408-1, 408-2, 408-N and stopped pumping if the particle moves away from the sensor 408-1, 408-2, 408-N (and further started in response to the particle again being detected). This continues for each microfluidic channel 404-1, 404-2, 404-N in the pairing region 402 until a particle is detected by each sensor 408-1, 408-2, 408-N. When respective particles are detected by each sensor 408-1, 408-2, 408-N, all fluid actuators 410-1, 410-2, 410-3, 410-4, 410-5, 410-P in the pairing region 402 may cease firing and the fluid ejector 422 of the droplet generator 416 is actuated or fired to pull the particles 406, 407-1, 407-R toward the merging chamber 420, along with the carrier fluid pulled from a reservoir into the third and fourth microfluidic channels 418-1, 418-2 (as illustrated by arrows 419-1, 419-2) and to the merging chamber 420, to form the fluid droplet 411 containing the particles 406, 407, 407-R, one from each microfluidic channel 404-1, 404-2, 404-N in the pairing region 402. Accordingly, the term “paired particles”, as used herein, is not limited to two particles, and may include a set of at least two particles (e.g., two or more), which includes one particle from each (input) microfluidic channel of the pairing region. The fluid ejector 422 may be further fired to eject the fluid droplet 411 from the microfluidic device 400.

In some examples, as illustrated by FIG. 4B, each microfluidic channel 404-1, 404-2, 404-N in the pairing region 402 includes a fluid ejector 412-1, 412-2, 412-3 fluidically coupled or disposed in the respective microfluidic channel 404-1, 404-2, 404-N. The microfluidic device 401 may include an implementation of the microfluidic device 400 of FIG. 4A, including at least some of substantially the same features and components, as illustrated by the common numbering, but with the fluid ejectors 412-1, 412-2, 412-3 disposed in the respective microfluidic channels 404-1, 404-2, 404-N. The microfluidic device 401 of FIG. 4B may operate at least substantially similar to FIG. 4A.

The microfluidic device and portions thereof illustrated by FIGS. 1A-4B may include a plurality of components combined in ways not shown specifically in FIGS. 1A-4B, as any of the components shown may be combined for a given application. A microfluidic device with a plurality of components may allow for alignment of multiple particle types at the same time, with fluid droplets containing one particle from each microfluidic channel of the pairing region. The fluid droplets may then be ejected and/or otherwise assessed to identify target first particles. For example, first particles may be B-cells which produce antibodies and the second particles may include sensor cells that model a particular pathway. Fluid droplets containing B-cells which produce antibodies that modulate the particular pathway may generate reaction products between the antibody and sensor cell that results in activation of an optical signal. As a particular and non-limiting example, the modulation of the pathway causes the sensor cell to activate beta-lactamase which then enzymatically converts a fluorogenic substrate of the sensor cell to a particular fluorescent signal. The fluid droplets that exhibit the particular fluorescent signal may then be sorted.

Any of the above-described microfluidic devices may be fabricated using integrated circuit microfabrication techniques, such as electroforming, laser ablation, anisotropic etching, sputtering, dry etching, wet etching, photolithography, casting, moulding, stamping, machining, spin coating, laminating, and the like. The microfluidic device may be manufactured from a variety of substrate materials. For example, the microfluidic device may include a material selected from glass, quartz, polyamide, polydimethylsiloxane, silicon, SU8, polystyrene, polycarbonate, polymethyl methacrylate, polyethylene, poly(ethylene glycol) diacrylate, polypropylene, perfluoroalkoxy, fluorinated ethylene propylene, polyurethane, cyclic olefin polymer, cyclic olefin copolymer, phenolics, or a combination thereof. In some examples, the microfluidic device is fabricated from polydimethylsiloxane. In some examples, the microfluidic device is fabricated from polycarbonate. In some examples, the microfluidic device is fabricated from silicon. In some examples, the microfluidic device is fabricated from SU8.

In various examples, the microfluidic devices described above may form part of an apparatus used to perform droplet sorting. The apparatus may be used to sort single fluid droplets containing paired particles to a substrate. Examples are not limited to single fluid droplet sorting, and may include dispensing a population of fluid droplets to different portions of the substrate. As previously described, the target particle may be detected in response to measuring a fluorescent signal associated with binding between first particle or derivative thereof and a second particle, and modulation of a pathway.

As a specific and non-limiting example, the first particles may include B-cells and the second particles may include sensor cells. A single B-cell may be paired with a single sensor cell and formed into a fluid droplet for incubation and for further selection and/or analysis. The B-cell and its produced antibody may be probed by the sensor cell to identify if the antibody modulates the pathway that the sensor cell is modified to model. If the pathway is modulated, the sensor cell expresses an enzyme that activates the particular optical signal. The fluid droplet may then be analyzed on device or off device for the presence of the optical signal. For example, the fluid droplet may be dispensed into and isolated in a region of an external substrate, such as a well of a multi-well plate. The substrate may be filled with different fluid droplets in different regions and the substrate may be analyzed to identify regions that exhibit the optical signal and/or which may exhibit the optical signal above a threshold. In some examples, a region of the substrate with the strongest optical signal is identified and the B-cell may be selected. In some examples, a plurality of regions of the substrate with the optical signal above the threshold may be identified and the particular B-cells may be selected, such as for further analysis, processing, and/or use in therapeutics. For example, the B-cell(s) may be selected and used to produce hybridoma cells. The selected B-cells may be effective at activating the target pathway, which the sensor cells are modified to model.

As another specific and non-limiting example, the first particles may include lymphocyte cells, such as primary T-cells. The second particles may include beads functionalized with an antibody, such as anti-interleukin antibodies. For example, the T-cells may be paired with the functionalized beads to assess for cytokine secretion from single T-cells. More particularly, and as a specific example, the T-cells may be paired with two functionalized beads, each functionalized with an antibody against a specific interleukin. Each bead has an antibody against a different domain of the interleukin, such that in the presence of the particular interleukin, a bead-interleukin-bead sandwich is formed. In the specific example, the bead carrying the first antibody is a donor bead, which may absorb excitation light (e.g., 680 nm). The bead carrying the second antibody is an acceptor bead, which may emit light (e.g., 520-620 nm). When the beads are connected through the analyte and when the donor bead is excited via excitation light, the donor bead coverts ambient oxygen to a more excited singlet state. The singlet state oxygen diffuses across to react with the thioxene derivative in the acceptor bead, generating chemiluminescent. These beads form a homogenous proximity assay Alpha screen. Other homogenous proximity assay may be used in various examples, and the above is provided as a non-limiting example only.

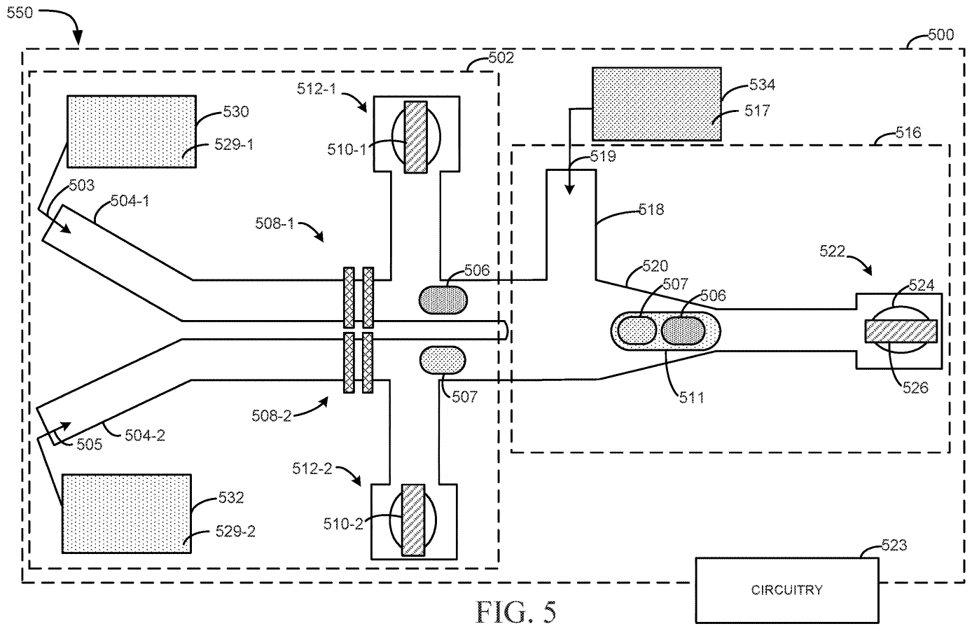

FIG. 5 illustrates an example apparatus including a pairing region, droplet generator, and circuitry, in accordance with examples of the present disclosure. As shown, the apparatus 550 includes a pairing region 502, a droplet generator 516, and circuitry 523.

In some examples, the pairing region 502 and droplet generator 516 of FIG. 5 form part of a microfluidic device 500 which may include an implementation of the microfluidic device 100 of FIGS. 1A-1B, including at least some of substantially the same features and components, as illustrated by the common numbering. The common features and components are not repeated for ease of reference. The microfluidic device 500 may include a housing that contains the pairing region 502 and the droplet generator 516, and the first reservoir 530, the second reservoir 532, and the third reservoir 534 are coupled to and/or supported by the housing (e.g., not contained or disposed within).

For example, the pairing region 502 includes a first microfluidic channel 504-1 including a first sensor 508-1 and a second microfluidic channel 504-2 including a second sensor 508-2. The first microfluidic channel 504-1 is fluidically coupled to a first fluid actuator 510-1 and a first reservoir 530 to receive a first aqueous fluid 529-1 including a first particle 506, as illustrated by arrow 503. The second microfluidic channel 504-2 is fluidically coupled to a second fluid actuator 510-2 and a second reservoir 532 to receive a second aqueous fluid 529-2 including a second particle 507, as illustrated by arrow 505. The first and second fluid actuators 510-1, 510-2 may form part of fluid ejectors 512-1, 512-2, in some examples.

In various examples, the first particle 506 and second particle 507 may include different types of particles. For example, the first particle 506 may include a biological particle, such as a living cell from a biologic sample. The second particle 507 may include a detection particle used to assess or screen the first particle 506 for a particular functionality. In some examples, the second particle 507 is a biological particle that models a pathway, such as sensor cell as previously described. However, examples are not so limited and other types of detection particles may include functionalized beads, among other variations as previously described herein.

The droplet generator 516 includes a merging chamber 520, a third microfluidic channel 518, and a fluid ejector 522. The merging chamber 520 is fluidically coupled to the first microfluidic channel 504-1, the second microfluidic channel 504-2, and the third microfluidic channel 518. The third microfluidic channel 518 is fluidically coupled to the merging chamber 520 and a third reservoir 534 to receive a carrier fluid 517, as illustrated by arrow 519. The fluid ejector 522 is fluidically coupled to the merging chamber 520.

The circuitry 523 may be communicatively coupled to various components of the microfluidic device 500, including the first fluid actuator 510-1, the second fluid actuator 510-2, the first sensor 508-1, the second sensor 508-2, and the fluid ejector 522. For example, the circuitry 523 is to selectively actuate the first fluid actuator 510-1, the second fluid actuator 510-2, and the fluid ejector 522 to align the first particle 506 and the second particle 507 in the pairing region 502 and to form a fluid droplet 511 containing the first particle 506 and the second particle 507 in the merging chamber 520. In some examples, the circuitry 523 is coupled to the first fluid actuator 510-1, the second fluid actuator 510-2, and the fluid actuator 526 of the fluid ejector 522 to selectively actuate the fluid actuators 510-1, 510-2, 526 to align the particles 506, 507 to form the fluid droplet 511 containing the first and second particles 506, 507, and eject the fluid droplet 511 from the microfluidic device 500 through the ejection nozzle 524 of the fluid ejector 522.

The operation of the apparatus 550 and/or microfluidic device 500 may be substantially similar to that previously described in connection with FIGS. 1A-1B. For example, the circuitry 523 may cause the first fluid actuator 510-1 and the second fluid actuator 510-2 to align the first particle 506 and the second particle 507 via actuation of the first fluid actuator 510-1 until the first sensor 508-1 detects the first particle 506 in the first microfluidic channel 504-1 and via actuation of the second fluid actuator 510-2 until the second sensor 508-2 detects the second particle 507 in the second microfluidic channel 504-2.

In some examples, the circuitry 523 may cause the first fluid actuator 510-1 to align the first particle 506 in the first microfluidic channel 504-1 with the second particle 507 in the second microfluidic channel 504-2 by adjusting a firing rate of at least one of the first fluid actuator 510-1 and the second fluid actuator 510-2 responsive to sensor signals from the first sensor 508-1 and the second sensor 508-2. For example, the circuitry 523 may actuate or fire the respective first or second fluid actuators 510-1, 510-2 at a reduced rate (e.g., half) responsive to the first sensor 508-1 detecting the first particle 506 in the first microfluidic channel 504-1, and without the second sensor 508-2 detecting the second particle 507 in the second microfluidic channel 504-2 or vice versa.

In some examples, the circuitry 523, in response to the alignment of the first particle 506 in the first microfluidic channel 504-1 and the second particle 507 in the second microfluidic channel 504-2, is to actuate the fluid ejector 522 to form the fluid droplet 511 containing the first particle 506 and the second particle 507 via flow of the first aqueous fluid 529-1 and the second aqueous fluid 529-2 with an angled, crossed, or co-flow of the carrier fluid 517 into the merging chamber 520.

The microfluidic device 500 of FIG. 5 may include any of the variations, and in any combination, as previously described herein.

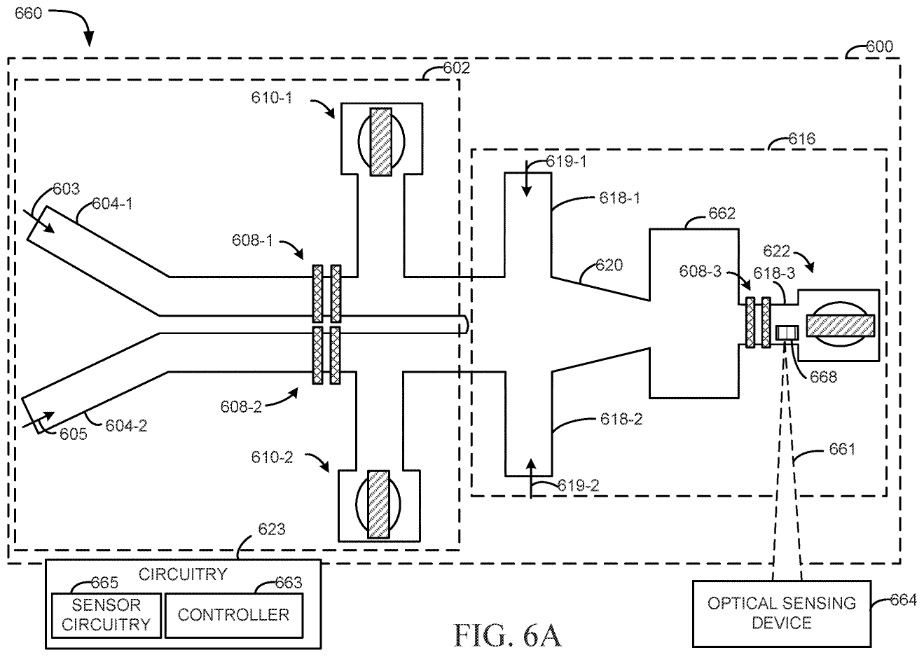

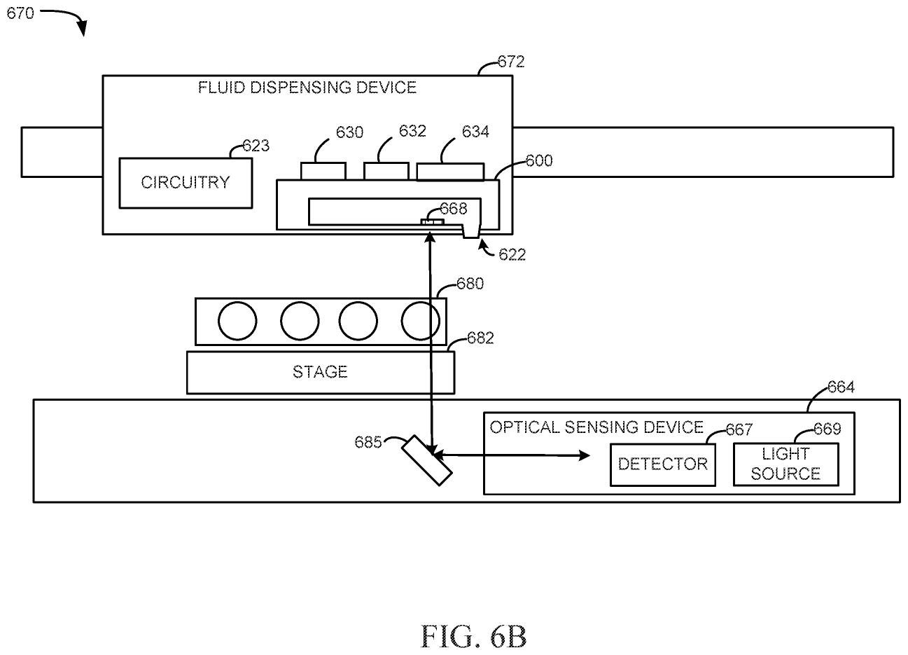

FIGS. 6A-6B illustrate further example apparatuses including a pairing region, droplet generator, an optical sensing device, and circuitry, in accordance with examples of the present disclosure. The apparatuses of FIGS. 6A-6B may include an implementation of the apparatus 550 of FIG. 5 and/or the microfluidic device 100 of FIGS. 1A-1B, including at least some of substantially the same features and components, as illustrated by the common numbering. The common features and components are not repeated for ease of reference. Each of the apparatuses 660, 670 of FIGS. 6A-6B may include a microfluidic device 600, circuitry 623, and an optical sensing device 664.

More particularly, the microfluidic devices 600 of FIGS. 6A-6B may include a pairing region 602 including a first microfluidic channel 604-1 including a first sensor 608-1 and fluidically coupled to the first fluid actuator 610-1, and a second microfluidic channel 604-2 including a second sensor 608-2 and fluidically coupled to the second fluid actuator 610-2. The first and second fluid actuators 610-1, 610-2 may draw aqueous fluid from reservoirs, as illustrated by the arrows 603, 605, and via actuation controlled by the circuitry 623.

The microfluidic devices 600 further includes a droplet generator 616 including the merging chamber 620, the third microfluidic channel 618-1, optional fourth microfluidic channel 618-2, and the fluid ejector 622. The fluid ejector 622 may be actuated by the circuitry 623 to draw aqueous fluids from the pairing region 602 and carrier fluid via the third microfluidic channel 618-1 (and optionally the fourth microfluidic channel 618-2) as illustrated by the arrows 619-1, 619-2, to form a fluid droplet containing paired particles.

The microfluidic device 600 further includes a merged droplet reservoir 662 fluidically coupled to the merging chamber 620 and a fourth (or fifth) microfluidic channel 618-3 fluidically coupled to the fluid ejector 622 and the merged droplet reservoir 662. The merged droplet reservoir 662 may include a space to allow for the paired particles to incubate and for a detectable reaction product to form that exhibits or causes an optical signal. The fourth (or fifth) microfluidic channel 618-3 may include an optically transparent window 668 that is a wall or a portion of the wall that is optically transparent. In various examples, the merged droplet reservoir 662 may be in a same layer of the microfluidic channels 604-1, 604-2, 618-1, 618-2.

As further illustrated herein, in some examples, the optically transparent window 668 forms or may include a collimating lens attached thereto. The optically transparent window 668 may be partially defined by an opposing or transverse wall (relative to the optically transparent window) that includes or provides access to an optical detector. An opposing wall is a wall that is located across from the optically transparent window. A traverse wall is a wall that is located along a plane that transects a plane of the optically transparent window, e.g., a perpendicular. An optical detector may be located with respect to the optically transparent window 668 such that a light beam passes through the optically transparent window 668 onto the optical detector or to an element capable of directing the light beam to the optical detector.

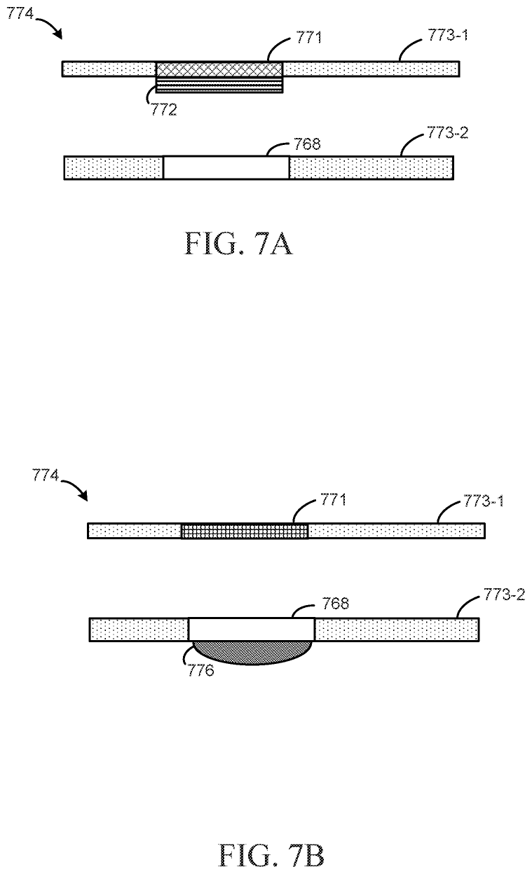

In other examples and as illustrated by FIG. 6A, an optical sensing device 664 separate from the microfluidic device 600 may be used that includes a light source to provide excitation light 661 toward the optically transparent window 668 and an optical detector to measure emitted light responsive to excitation light 661. The optical sensing device 664 is to measure emitted light responsive to excitation light 661 provided toward the optically transparent window 668. For example and as illustrated by FIG. 6B, the optical sensing device 664 may include a light source 669 and optical detector 667. Referring back to FIG. 6A, the light source may provide excitation light 661 toward the optically transparent window 668 and/or the optical detector measures emitted light in response to the excitation light. The light source may be positioned to emit or reflect light toward the optically transparent window 668. In some examples, the optical sensing device 664 may include the light source to provide excitation light 661 and the optical detector may form part of the microfluidic device 600, as further described in connection with FIGS. 7A-7B. The optical detector may measure optical signals emitted from components within the fluid present in the fifth microfluidic channel 618-3, such as the fluorescent signal associated with a detectable reaction product forming.

In some examples, the microfluidic device 600 includes a third sensor 608-3 which is disposed with or in the fifth microfluidic channel 618-3. The third sensor 608-3 may be used to detect for the presence of a fluid droplet containing particles in the fifth microfluidic channel 618-3, and in response, the optical sensing device 664 is activated.

The circuitry 623 is communicatively coupled to the microfluidic device 600 and the optical sensing device 664 to drive flow of the fluid through the microfluidic device 600 via the fluid actuators 610-1, 610-2 and the fluid ejector 622 and to detect an optical signal indicative of a reaction product via the measured emitted light. In some examples, the circuitry 623 is separate from the microfluidic device 600, or in other examples, is an integrated part. The circuitry 623 may include electrical connections to the fluid actuators 610-1, 610-2, the sensors 608-1, 608-2, 608-3, and/or fluid ejector 522. The circuitry 623 may include a controller 663 to control timing of the fluid flow through the microfluidic device 600 and/or cause ejection of fluid from the microfluidic device 600, cause movement of the microfluidic device 600 and/or the stage (as described below) to align individual regions of a substrate, such as a multi-well plate with the nozzle of the fluid ejector 622, or set a vertical distance between fluid in the substrate and the ejection nozzle of the fluid ejector 622.

Although not illustrated by FIGS. 6A-6B, the controller 663 may further communicatively couple to a light source and optical detector. The light source and optical detector may form part of the microfluidic device 600, such as illustrated by FIGS. 7A-7B, and/or may form part of the optical sensing device 664 that is separate from the microfluidic device 600 as illustrated by FIG. 6B. The controller 663 may instruct the light source or the optical sensing device 664 to emit excitation light toward the optically transparent window 668 and may receive the measured emitted light, in response to the excitation light, from the optical detector. The excitation light may excite the fluorophore or other moiety of a probe associated with the second particle, if the pathway of the sensor cell is activated, is inhibited, or a probe is otherwise activated, and in response, the probe may emit light that includes a fluorescent signal associated with the presence of a target particle. The probe may provide the particular fluorescent signal in response to the pathway being modulated and/or binding to the target. Prior to the activation or binding, the particular fluorescent signal is not present.

The flow of the aqueous fluids through the pairing region 602 to pair particles and into the merging chamber 620 to form fluid droplet containing the paired particles may include at least some of substantially the same operation as described in connection with FIGS. 1A-1B.

In some examples, the circuitry 623 includes sensor circuitry 665 to receive sensor signals from sensors 608-1, 608-2, 608-3 and provide the sensor signals to the controller 663, which may be used to align the particles, as feedback, and/or may indicate whether or not a fluid droplet containing particles has passed through sensor 608-3 in the microfluidic device 600. Example sensor circuitry 665 includes electrical connections to the electrodes or other components forming the sensors 608-1, 608-2, 608-3 and hardware components (e.g., capacitors, resistors, ground connections, power source, switches, and processing circuitry) to obtain sensor signals therefrom, such as signals indicative of changes in impedance. Depending on the sensor and sensor data, the feedback may indicate whether or not a particle or fluid droplet is present proximate to the respective sensor 608-1, 608-2, 608-3 and whether or not to perform optical detection, and/or an alignment of a region of the substrate (e.g., 680 of FIG. 6B) to which a fluid droplet may be ejected into.

For example, and referring to FIG. 6B, when sensor signal(s) indicates that a particle or fluid droplet containing particles is present, the circuitry 623 directs alignment of an empty region (e.g., well) in the substrate 680 (e.g., multi-well plate) with the ejection nozzle of the microfluidic device 600. Following the alignment, the circuitry 623 may direct the fluid ejector 622 to eject the fluid droplet containing particles therein into the empty region, thereby allowing individual regions of the substrate 680 to be filled with an individual set of paired particles. When sensor signal(s) indicates that a fluid droplet containing particles is not present or may not contain a set of paired particles, then the circuitry 623 may direct alignment of a waste region of the substrate 680 with the ejection nozzle of the fluid ejector 622. Following alignment of the waste region and the ejection nozzle, the circuitry 623 may direct the fluid ejector 622 to eject a fluid droplet of the fluid into the waste region which includes fluid droplets not of interest for further processing and/or assessment.

In some examples, as shown by FIG. 6B, the apparatus 670 may further comprise a substrate 680 and a stage 682 coupled to the substrate 680. The substrate 680 may include a plurality of regions, such as a multi-well plate having a plurality of wells to eject fluids to.

In some examples, the circuitry 623 is communicatively coupled to the stage 682 to instruct the stage 682 to move the substrate 680 relative to the fluid ejector 622, such that the fluid ejector 622 is aligned with a select region of the plurality of regions of the substrate 680. The fluid ejector 622 may selectively eject a fluid droplet containing the particles from the microfluidic device 600 to the select region of the substrate 680, as previously described.

In some examples, the first aqueous fluid received by the first reservoir 630 includes a plurality of first particles and the second aqueous fluid received by the second reservoir 632 includes a plurality of second particles, which are a different type than the plurality of first particles. For example and as previously described, the first aqueous fluid may include a biologic sample in a buffer fluid containing a plurality of living cells, such as antibody-producing cells (e.g., B-cell or hybridoma cells). The second aqueous fluid may include a buffer fluid containing a plurality of detection particles. Examples are not so limited.

Referring back to FIG. 6A, in some examples, the circuitry 623 may assess for a presence of the fluid droplet containing particles in the fifth microfluidic channel 618-3 using a sensor signal from sensor 608-3, and in response, activate the optical sensing device 664 to output excitation light. The circuitry 623 may further assess for a presence of a reaction product in the fluid droplet based on an optical signal detected by the optical sensing device 664, and actuate the fluid ejector 622 to cause selective ejection of the fluid droplet containing particles from the microfluidic device 600 to a region of the substrate based on the assessed presence. Referring back to FIG. 6B, to selectively eject a plurality of fluid droplets containing particles to different regions of the substrate 680, the circuitry 623 may instruct the stage 682 to move the substrate 680 relative to the fluid ejector 622, as described above.

In some examples, the circuitry 623 and/or the controller 663 may include a processor and memory. Memory may include a computer-readable storage medium storing a set of instructions. Computer-readable storage medium may include Read-Only Memory (ROM), Random-Access Memory (RAM), Electrically Erasable Programmable Read-Only Memory (EEPROM), flash memory, a solid state drive, physical fuses and e-fuses, and/or discrete data register sets. In some examples, computer-readable storage medium may be a non-transitory storage medium, where the term “non-transitory” does not encompass transitory propagating signals.

The processor may be a central processing unit (CPU), a semiconductor-based microprocessor, a graphics processing unit (GPU), a microcontroller, special purpose logic hardware controlled by microcode or other hardware devices suitable for retrieval and execution of instructions stored in the non-transitory computer-readable storage medium, or combinations thereof. The circuitry 623 and/or controller 663 may fetch, decode, and execute instructions, as described herein. As an alternative or in addition to retrieving and executing instructions, the circuitry 623 may include an integrated circuit (IC), other control logic, other electronic circuits, or combinations thereof that include electronic components for performing the functionality of instructions.

As an example, the sensor circuitry 665 may couple to the first sensor 608-1, the second sensor 608-2, and the third sensor 608-3 and obtain sensor signals therefrom, such as from electrodes forming impedance sensors. The sensor signals may be associated with or indicative of particles and/or fluid droplets containing particles passing by the respective sensors 608-1, 608-2, 608-3 in the respective microfluidic channels 604-1, 604-2, 618-3. The controller 663 may be coupled to the sensor circuitry 665 to receive the sensor signals and, in response, selectively actuate fluid actuators 610-1, 610-2 and/or fluid ejector 622. The sensor signals may include a first sensor signal associated with a first particle as the first particle passes by the first sensor 608-1 in the first microfluidic channel 604-1, a second sensor signal associated with a second particle as the second particle passes by the second sensor 608-2 in the second microfluidic channel 604-2, and a third sensor signal associated with a fluid droplet containing particles as the fluid droplet passes by the third sensor 608-3 in the fifth microfluidic channel 618-3.

In some examples, each of the sensors 608-1, 608-2, 608-3 includes a set of electrodes, with an electrode being grounded and another (or multiple) being coupled to a component of the sensor circuitry 665. The sensing electrodes provide an electric field therebetween. Fluid containing the particles is conductive, as previously described. As the particle (or fluid droplet containing particles) flows through the electric field, an impedance measure is obtained as a sensor signal by the first sensor 608-1, the second sensor 608-2, and/or the third sensor 608-3. For example, the sensor circuitry 665 applies a voltage or current to the one (or more) electrode of the set, with the other electrode being grounded, and which causes the electric field to be applied within the first microfluidic channel 604-1, the second microfluidic channel 604-2, and/or the fifth microfluidic channel 618-3. The resulting impedance measure may be indicative of the particle or fluid droplet containing particles passing by. The impedance measure may be used to trigger activation of the coupled optical sensing device 664 and/or the fluid ejector 622 for ejecting a fluid droplet containing particles. Although the above describes impedance measures or signals, examples are not limited to impedance sensors and may include other types of signals which obtain other electrical signals.

FIG. 6B illustrates an example implementation of the apparatus 670 of FIG. 6A, with additional and optional components illustrated including a fluid dispensing device 672. The common features and components are not repeated for ease of reference. Although FIG. 6A-6B illustrates the optical sensing device 664 interrogating the fluid droplet while the fluid droplet is located in the microfluidic device 600, examples are not so limited. In various examples, the fluid droplet containing particles may be ejected from the microfluidic device 600 to the substrate 680 for assessment and/or further assessment.

As shown by FIG. 6B, the apparatus 670 may include a fluid dispensing device 672. The fluid dispensing device 672 includes a substrate transport assembly and the circuitry 623. The substrate transport assembly may include a stage 682 coupled to one of the substrate 680 and the fluid dispensing device 672 to move a position of the substrate 680 with respect to the microfluidic device 600. The fluid dispensing device 672 may include additionally non-illustrated components, such as a mounting assembly and a power supply that provides power to the various electrical components of the fluid dispensing device 672 and the microfluidic device 600 mounted therein. The fluid dispensing device 672 may control a fluid ejector 622 of the microfluidic device 600 to dispense fluid droplets to the substrate 680. The fluid dispensing device 672 may cause flow of aqueous fluids from first and second reservoirs 630, 632 through a pairing region to a merging chamber with the flow of carrier fluid from the third reservoir 634 to form fluid droplet containing particles, which are flowed to the fluid ejector 622, and then cause the fluid ejector 622 eject a volume of the fluid from the microfluidic device 600 to a region of the substrate 680.

As described above, the apparatus 670 may include the substrate 680. The substrate 680 may include different regions, such as wells of a well plate, with each region getting paired particles depending on determined properties. These dispense locations may be specific target regions on the substrate surface, such as cavities, microwells, channels, indentation into the substrate, or other regions of the substrate. A region refers to or includes a particular location of a substrate to which fluid droplet containing particles is to be dispensed.

In the example illustrated by FIG. 6B, the optical sensing device 664 includes an optical detector 667, a light source 669, and a mirror 685. The light source 669 is positioned such that excitation light may be emitted or reflected toward the optically transparent window in the microfluidic device 600.

A variety of different light sources may be used, such as a laser, a light-emitted diode (LED), an infrared light source, a near infrared light source, xenon arc lamp, mercury light lamp, halogen light lamp, among other light sources. The light source 669 may emit the excitation light at a particular electromagnetic energy to excite the resulting reaction product formed between the detection particle and a living cell or a derivative thereof. In some examples, the light source 669 may use bright field imaging to illuminate the fluid. Bright field imaging may allow for some cells or other particles in the fluid to appear dark when surrounded by the bright viewing field. In other examples, as further illustrated herein, the light source may include a multi-spectral light source.

The wavelength range of the excitation light, sometimes herein referred to as an emission range, may be correlated to the fluorescent signal of the second particle when a particular reaction product is formed between the first particle (or derivative thereof) and second particle. For example, the light source 669 may emit excitation light in a wavelength range that overlaps with the wavelength of the fluorescent signal. In some examples, the correlation may occur by the light source 669 which includes a plurality of individual illuminators that may be selectively turned on and off. In some examples, as further illustrated herein, excitation light emitted by the light source 669 may be emitted towards a filter cube, a spectral filter, a beam splitter, a reflective direction source, such as the mirror 685, a prism, and combinations thereof. In some examples, wavelengths of excitation light that do not correlate with the excitement energy of the probe may be filtered or directed away from the optically transparent window 668. Further, the excitation light may be directed or focused using the mirror 685 and/or an objective lens.

The optical detector 667 may measure or receive and pass along the optical measure. In some examples, the optical detector 667 may include a fluorimeter, a photoluminescence spectrometer, a semiconductor such as a p-n junction diode, a photodiode, a phototransistor, or a combination thereof. In yet other examples, the optical detector 667 may be a detector array. The optical detector 667 may be positioned to detect fluorescence from a reaction product formed by the first particle reacting with the second particle. The optical detector 667 may be a standalone component and/or may be integrated with the microfluidic device 600, as further described below. In some examples, the optical detector 667 may be positioned on a linear substrate designed to be placed between a stage 682 and the substrate 680.

In some examples, the excitation light may be provided through the stage 682 and the substrate 680, such as through a waste region, with both the stage 682 and the substrate 680 including optically transparent windows. For example, the stage 682 and substrate 680, or portions thereof, may include or be optically transparent to allow for positioning of the light source 669 and/or the optical detector 667 below the stage 682. As described above, the stage 682 and the microfluidic device 600 are movable in relation to one another. The movable component may be the stage 682, the microfluidic device 600, or a combination thereof. The movement may allow for the aligning of individual regions of the substrate 680, such as wells of a multi-well plate, with the ejection nozzle of the fluid ejector 622 on the microfluidic device 600. The movement may also align a height of the substrate 680 with respect to the bottom of the ejection nozzle of the fluid ejector 622. In some examples, the substrate 680 and the ejection nozzle may be spaced apart at from 0.5 mm 5 to 5 mm, from 1 mm to 4 mm, or from 1 mm to 3 mm. Minimizing a distance between the top of the substrate 680 and the ejection nozzle may, in some instances, minimize fluid loss from a misdirected or displaced droplet, e.g., being blown off course, during ejecting and depositing in a region of the substrate 680. In some examples, the stage 682 may be modified to permit movement of the light source 669, the optical detector 667, or a combination thereof, a corollary amount when the stage 682 is moved. In some examples, the stage 682 may include a coupling for mounting of the light source 669, the optical detector 667, or a combination thereof.

FIGS. 7A-7B illustrate example regions of a microfluidic device including an optically transparent window, in accordance with examples of the present disclosure. The regions 774 illustrated by FIGS. 7A-7B may be implemented in any of the microfluidic devices and/or apparatuses as illustrated by FIGS. 1A-6B. For example, the region 774 of FIGS. 7A-7B may be in a portion of the fifth microfluidic channel 618-3 of the microfluidic device 600 illustrated by FIG. 6A.

The region 774 includes an optically transparent window 768 associated with a wall 773-2 of the region 774. In some examples, the wall 773-2 may be a substrate or in a substrate of the microfluidic device, such as in a side wall of the device disposed with or forming part of a microfluidic channel or chamber.

In some examples, and referring to FIG. 7A, the region 774 includes an opposing wall 773-1 that includes an optical detector 771 optically coupled to an optical filter 772. The optical detector 771 may be associated with the wall 773-1 which opposes the wall 773-2 having the optically transparent window 768 or may be located on a traverse wall relative to the optically transparent window 768. A traverse wall refers to or includes a wall that is located along a plane that transects a plane of the optically transparent window 768, e.g., is perpendicular. In some examples, the microfluidic device may include a light directing element which directs light towards the opposing wall 773-1. The optical detector 771 may include a band pass filter with a p-n junction diode, a camera detector, a charged coupling device (CCD) detector, a photo-sensor, a complementary metal oxide semiconductor (CMOS) detector, among other, which is located on the opposing wall 773-1.

In some examples, the optical detector 771 includes a photo-sensor, such as a photodetector or photoelectric sensor. The photo-sensor may include a light emitter and a receiver. The light emitter may emit light to be received by the receiver. In some examples, the photo-sensor is a photoelectric sensor that may have a through-beam arrangement where the emitter and the receiver are positioned on opposite sides of a flow way. In some examples, a photoelectric sensor may have a retroreflective arrangement where the emitter and the receiver may be positioned on the same side of a flow way and a reflector may reflect and/or direct light to the photoelectric sensor. An interruption in the light detected by the photoelectric sensor may evidence passage of a cell.

As shown by FIG. 7B, in some examples, the optically transparent window 768 forms or has a collimating lens 776 attached thereto. The region 774 may include an optical detector 771, as previously described. The collimating lens 776 may narrow and focus light towards a specific direction. In some examples, the collimating lens 776 may filter out light rays which are not traveling parallel to the direction of light rays that pass through the collimating lens 776. The collimating lens may be a refractive lens, a Fresnel lens, or a diffractive lens. A refractive lens bends light rays. A Fresnel lens is a specific type of composite compact lens having a large aperture and short focal length. Fresnel lenses may be thinner than other lenses. A diffractive lens has thin elements that may make use of the wave nature of light. Diffractive lenses modify the phase of light using micro-structure patterns fabricated on a surface of the lens. Light that passes through sunken areas travels faster than light that travels through higher areas of the lens creating controlled phase delay. In some examples, the collimating lens may be a lens that is refractive, brazed, saw-tooth, amplitude, binary, quaternary, or sinusoidal. A refractive lens may allow for about ninety-five % to about a hundred % collimation when fabricated using gray scale lithography and polishing. In some examples, a refractive lens may be a gradient refractive lens. A blazed lens may allow for about ninety % to about a hundred % collimation when fabricated using gray scale lithography and diamond turning. A saw-tooth lens may allow for about eighty-five % to about ninety % collimation when fabricated by diamond turning. An amplitude lens may allow for about eight % to about ten % collimation when fabricated using lithography. A binary lens may allow for about thirty-five % to about forty % collimation when fabricated using lithography. A quaternary lens may allow for about seventy % to about eighty-five % collimation when fabricated using lithography. A sinusoidal lens may allow for about twenty-five % to about thirty-five % collimation when fabricated using holographic exposure. The collimating lens 776 may direct light into region 774.

In some examples, the opposing wall 773-2, which may be positioned transverse or opposite the optically transparent window 768, may include an optical detector 771. The term “defines” is inclusive of examples where the wall partially or fully defines the region 774. A component attached to or embedded in a wall may partially define the region 774, e.g., recessed or partially recessed optical detector or other component. The optical detector 771 may be positioned to receive optical signals, such as fluorescent signals. In some examples, the optical detector 771 may include a pin-photodiode, an avalanche photodiode, a phototransistor, a multi-junction photodiode, a CCD, a CMOS device, a photo-sensor, an image sensor, a photo-resistor, a pyroelectric detector, a thermopile, a CMOS image sensor, a CMOS image sensor, and combinations thereof. In other examples, the optical detector 771 includes a pin-photodiode. In some examples, the optical detector 771 includes a multi-junction photodiode. In other examples, the optical detector 771 includes a camera sensor. In some examples, the optical detector 771 includes a CMOS image sensor. In some examples, the optical detector 771 includes a CCD image sensor. In some examples, the optical detector 771 is coupled to an optical filter, such as a band pass filter, such as illustrated by FIG. 7A. In various examples, the optical detector 771 may be an imaging or non-imaging optical detector.

However, examples are not limited to the regions 774 illustrated in FIGS. 7A-7B. In some examples, external optical sensing circuitry may be used. Further, in some examples, a sensor may be disposed before or within the region 774, such as an impedance sensor to sense impedance of the fluid flowing to the region 774, as previously described.

The figures herein illustrate particular numbers of microfluidic channels, constriction portions, and fluid ejectors However, examples are not limited, and may include variety of different orientations. Although the various apparatus illustrate symmetrical designs, examples are not so limited. For example, the microfluidic devices may include high through-put and/or parallel designs.

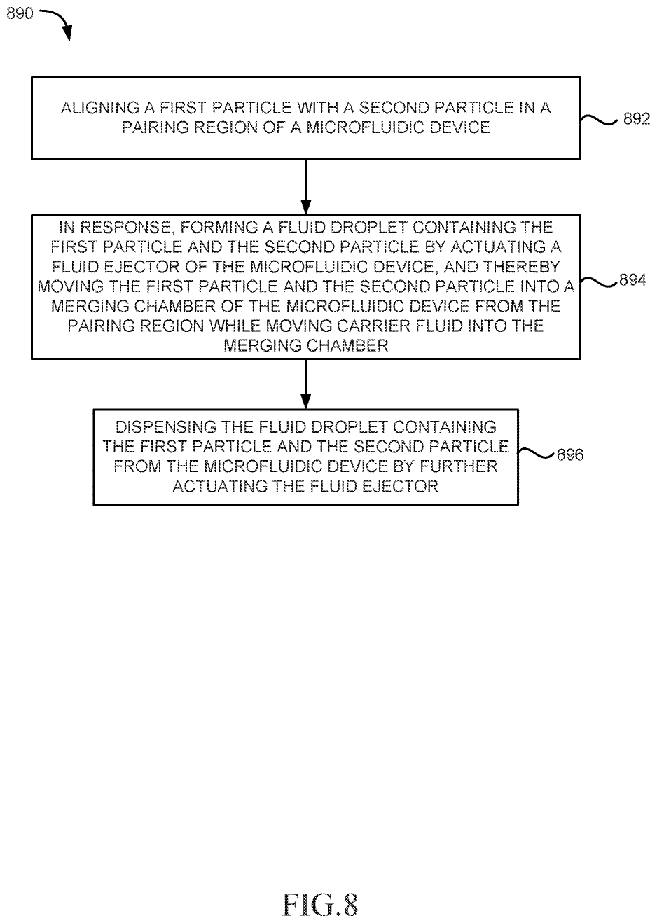

FIG. 8 illustrates an example method for pairing and sorting particles using a microfluidic device, in accordance with the present disclosure. The method 890 may be performed by any of the microfluidic devices and/or apparatuses as described in connection with FIGS. 1A-6B.

At 892, the method 890 includes aligning a first particle with a second particle in a pairing region of a microfluidic device by actuating a first fluid actuator of the microfluidic device until a first sensor disposed in a first microfluidic channel detects a presence of the first particle, and actuating a second fluid actuator of the microfluidic device until a second sensor disposed in a second microfluidic channel detects a presence of the second particle. In some examples, the method 890 may include aligning the first particle in the first microfluidic channel parallel with the second particle in the second microfluidic channel by selectively actuating the first fluid actuator, the second fluid actuator, or combinations thereof.

At 894, the method 890 includes, in response, forming a fluid droplet containing the first particle and the second particle by actuating a fluid ejector of the microfluidic device, and thereby moving the first particle and the second particle into a merging chamber of the microfluidic device from the pairing region while moving carrier fluid into the merging chamber. And, at 896, the method 890 includes dispensing the fluid droplet containing the first particle and the second particle from the microfluidic device by further actuating the fluid ejector.

In some examples, the first particle includes an antibody-producing cell and the second particle includes a sensor cell that forms a detectable reaction product with a target antibody secreted by the antibody-producing cell, and the fluid droplet contains the single antibody-producing cell and the single sensor cell. However, examples are not so limited and may be directed to variety of different particles, including different biological particles and detection particles.

While the above method describes aligning first and second particles, in various examples, the method 890 may be repeated to generate a plurality of fluid droplets, with each fluid droplet include a paired first particle and second particle or more. In some examples, more than two particles may be aligned, such as aligning a biological particle with a plurality of detection particles.

Circuitry, such as circuitry 223, 523, and 623, includes a processor, machine readable instructions, and other electronics for communicating with and controlling the fluid actuators, and other components, such as the sensors, the fluid pump(s) and/or resistor(s), and other components. The circuitry may receive data from a host system, such as a computer, and includes memory for temporarily storing data. The data may be sent to the apparatus along an electronic, infrared, optical, or other information transfer path. A processor may be a CPU, a semiconductor-based microprocessor, a GPU, a microcontroller, special purpose logic hardware controlled by microcode or other hardware devices suitable for retrieval and/or execution of instructions stored in a memory, or combinations thereof. In addition to or alternatively to retrieving and executing instructions, the processor may include at least one IC, other control logic, other electronic circuits, or combinations thereof that include a number of electronic components for performing the function. In some examples, the circuitry includes non-transitory computer-readable storage medium that is encoded with a series of executable instructions that may be executed by the processor. Non-transitory computer-readable storage medium may be an electronic, magnetic, optical, or other physical storage device that contains or stores executable instructions. Thus, non-transitory computer-readable storage medium may be, for example, RAM, an EEPROM, a storage device, an optical disc, etc. In some examples, the computer-readable storage medium may be a non-transitory storage medium, where the term ‘non-transitory’ does not encompass transitory propagating signals.

A fluid may include a biologic sample in a fluid, sometimes referred to herein as “a biologic sample fluid”. A biologic sample, as used herein, refers to any biological material, collected from a subject. Examples of biologic samples include, but are not limited to, whole blood, blood plasma, and other body fluids, as well as tissue cell cultures obtained from humans, plants, or animals. Such biologic samples may contain any viral or cellular material, including all prokaryotic or eukaryotic cells, viruses, bacteriophages, mycoplasmas, protoplasts, and organelles. The biological material may comprise all types of mammalian and non-mammalian animal cells, plant cells, algae including blue-green algae, fungi, bacteria, protozoa, etc. Non-limiting sample examples include whole blood and blood-derived products such as plasma, serum and buffy coat, urine, feces, cerebrospinal fluid or other body fluids, tissues, cell cultures, cell suspensions, etc. The term “fluid” refers to any substance that flows under applied forces. In some examples, the fluid includes the biologic sample including an analyte and/or a reagent or reactant, among others.

The various ranges provided herein include the stated range and any value or sub-range within the stated range. Furthermore, when “about” is utilized to describe a value or percentage this includes, refers to, and/or encompasses variations (up to +/−ten %) from the stated value or percentage. In describing and claiming the examples disclosed herein, the singular forms “a”, “an”, and “the” include plural referents unless the context clearly dictates otherwise.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A microfluidic device, comprising:
a pairing region including:
a first microfluidic channel including a first sensor, the first microfluidic channel fluidically coupled to a first fluid actuator and to receive a first aqueous fluid; and
a second microfluidic channel including a second sensor, the second microfluidic channel fluidically coupled to a second fluid actuator and to receive a second aqueous fluid; and
a droplet generator including:
a merging chamber fluidically coupled to the first microfluidic channel, the second microfluidic channel, and a third microfluidic channel;
the third microfluidic channel fluidically coupled to the merging chamber and to receive a carrier fluid; and
a fluid ejector fluidically coupled to the merging chamber.

2. The microfluidic device of claim 1, further including circuitry to align a first particle of the first aqueous fluid in the first microfluidic channel with a second particle of the second aqueous fluid in the second microfluidic channel via actuation of the first fluid actuator and the second fluid actuator and based on sensor signals from the first sensor and second sensor, and to form a fluid droplet containing the first particle and the second particle in the merging chamber via selective actuation of the fluid ejector.

3. The microfluidic device of claim 1, wherein the pairing region further includes a first branching channel that intersects the first microfluidic channel and a second branching channel that intersects the second microfluidic channel, the first fluid actuator disposed within the first branching channel and the second fluid actuator disposed within the second branching channel.

4. The microfluidic device of claim 1, wherein the first fluid actuator and the second fluid actuator are respectively disposed in the first microfluidic channel and in the second microfluidic channel.

5. The microfluidic device of claim 1, wherein the first microfluidic channel and the second microfluidic channel are disposed in series with the merging chamber, and the first microfluidic channel and the second microfluidic channel are disposed in parallel with one another.

6. The microfluidic device of claim 1, wherein the first sensor is disposed upstream from a first junction between the first microfluidic channel and the first fluid actuator, and the second sensor is disposed upstream from a second junction between the second microfluidic channel and the second fluid actuator.

7. The microfluidic device of claim 6, further including a third sensor disposed downstream from the first junction and a fourth sensor disposed downstream from the second junction, wherein the third sensor and the fourth sensor are disposed upstream from the merging chamber.

8. The microfluidic device of claim 1, wherein the droplet generator further includes a fourth microfluidic channel fluidically coupled to the merging chamber and to receive the carrier fluid, wherein the third microfluidic channel and the fourth microfluidic channel are disposed to provide cross flows of the carrier fluid into the merging chamber.

9. An apparatus, comprising:
a pairing region including:
a first microfluidic channel including a first sensor, wherein the first microfluidic channel is fluidically coupled to a first fluid actuator and a first reservoir to receive a first aqueous fluid including a first particle; and
a second microfluidic channel including a second sensor, wherein the second microfluidic channel is fluidically coupled to a second fluid actuator and a second reservoir to receive a second aqueous fluid including a second particle;
a droplet generator including:
a merging chamber fluidically coupled to the first microfluidic channel and the second microfluidic channel;
a third microfluidic channel fluidically coupled to the merging chamber and a third reservoir to receive a carrier fluid; and
a fluid ejector fluidically coupled to the merging chamber; and
circuitry to selectively actuate the first fluid actuator, the second fluid actuator, and the fluid ejector to align the first particle and the second particle in the pairing region and to form a fluid droplet containing the first particle and the second particle in the merging chamber.

10. The apparatus of claim 9, wherein the pairing region and droplet generator form part of a microfluidic device including a housing that contains the pairing region and the droplet generator, wherein the first reservoir, the second reservoir, and the third reservoir are coupled to the housing.

11. The apparatus of claim 9, wherein the circuitry is to cause the first fluid actuator and the second fluid actuator to align the first particle and the second particle via actuation of the first fluid actuator until the first sensor detects the first particle in the first microfluidic channel and via actuation of the second fluid actuator until the second sensor detects the second particle in the second microfluidic channel.

12. The apparatus of claim 9, wherein the circuitry is to cause the first fluid actuator to align the first particle in the first microfluidic channel with the second particle in the second microfluidic channel by adjusting a firing rate of at least one of the first fluid actuator and the second fluid actuator responsive to sensor signals from the first sensor and the second sensor.

13. The apparatus of claim 9, wherein the circuitry, in response to the alignment of the first particle in the first microfluidic channel and the second particle in the second microfluidic channel, is to actuate the fluid ejector to form the fluid droplet containing the first particle and the second particle via flow of the first aqueous fluid and the second aqueous fluid with an angled, crossed, or co-flow of the carrier fluid into the merging chamber.

14. A method, comprising:
aligning a first particle with a second particle in a pairing region of a microfluidic device by:
actuating a first fluid actuator of the microfluidic device until a first sensor disposed in a first microfluidic channel detects a presence of the first particle; and
actuating a second fluid actuator of the microfluidic device until a second sensor disposed in a second microfluidic channel detects a presence of the second particle;
in response, forming a fluid droplet containing the first particle and the second particle by actuating a fluid ejector of the microfluidic device, and thereby moving the first particle and the second particle into a merging chamber of the microfluidic device from the pairing region while moving carrier fluid into the merging chamber; and
dispensing the fluid droplet containing the first particle and the second particle from the microfluidic device by further actuating the fluid ejector.

15. The method of claim 14, wherein the first particle includes an antibody-producing cell and the second particle includes a sensor cell that forms a detectable reaction product with a target antibody secreted by the antibody-producing cell, and the fluid droplet contains the single antibody-producing cell and the single sensor cell.
